(19) United States
(12) Patent Application Publication
(10) Pub. No.: US 2026/0193798 A1
(43) Pub. Date: Jul. 9, 2026

(54) NANOPARTICLE BASED ELECTROCATALYSTS FOR WATER SPLITTING

(71) Applicant: KING FAHD UNIVERSITY OF PETROLEUM AND MINERALS, Dhahran (SA)

(72) Inventors: Abuzar KHAN, Dhahran (SA); Aniz Chennampilly UMMER, Dhahran (SA); Mohammad FURQUAN, Dhahran (SA)

(73) Assignee: KING FAHD UNIVERSITY OF PETROLEUM AND MINERALS, Dhahran (SA)

(21) Appl. No.: 19/015,251

(22) Filed: Jan. 9, 2025

(51) Int. Cl. C25B 11/091; B82Y 30/00; B82Y 40/00; C25B 1/04; C25B 11/031; C25B 11/065; C25B 11/089; C25B 15/025

(52) U.S. Cl. CPC C25B 11/091; C25B 1/04; C25B 11/031; C25B 11/065; C25B 11/089; C25B 15/025; B82Y 30/00; B82Y 40/00

(57) ABSTRACT

A method of forming a catalytic electrode that includes depositing particles of a metal-organic framework onto a conductive substrate to form a coated substrate, exposing the coated substrate to a laser having a wavelength (λ) of 5 μm to 10 μm and a power of 25 W to 35 W to form a carbonized product, and washing the carbonized product to obtain the catalytic electrode. The metal organic framework is at least one selected from the group consisting of a copper containing metal organic framework and a cobalt/nickel containing metal organic framework. The carbonized product includes a carbon-containing porous scaffold, and nanoparticles which are at least one selected from the group consisting of cobalt-nickel (Co—Ni) alloy nanoparticles and copper oxide (CuO) nanoparticles disposed on the carbon-containing porous scaffold.

### BACKGROUND

### TECHNICAL FIELD

The present disclosure is directed towards an electrocatalytic electrode supported on a cobalt-nickel (Co—Ni) nanoparticle based conductive substrate for electrochemical water splitting.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The growing global energy demand and environmental concerns have highlighted the need for clean energy solutions. Electrochemical water splitting offers a sustainable method to produce hydrogen (H₂) and oxygen (O₂), which are efficient energy carriers with no carbon emissions. However, the process of electrocatalysis suffers from high overpotentials and slow kinetics, limiting overall efficiency of catalysts and increase energy consumption. In general, the performance of water electrolysis heavily depends on electrocatalyst used, with platinum (Pt) and Pt-based alloys being the most widely-used HER catalysts, and RuO₂ and IrO₂ being the most widely-used for OER. However, the limited availability and high cost of these materials hinder large-scale commercial use, necessitating the development of cost-effective alternatives to enhance efficiency and reduce costs. Additionally, traditional catalysts for water electrolysis have low activity and involve complex, resource-intensive preparation processes. Therefore, developing efficient catalysts to accelerate water electrolysis is crucial for reducing costs and improving performance. As a result, significant efforts have focused on developing more affordable, stable, and abundant alternatives, such as electrocatalysts that use earth-abundant elements. These materials offer cost-effectiveness while enhancing the efficiency of hydrogen and oxygen generation, making them promising candidates for sustainable energy solutions.

Metal-organic frameworks (MOFs) are crystalline materials formed by metal ions and organic ligands, creating tunable, three-dimensional structures. With high porosity, large surface area, and diverse topologies, metal-organic frameworks are versatile for various applications. metal-organic frameworks may be synthesized through methods like solvothermal, hydrothermal, electrochemical, and room temperature synthesis. Solvothermal synthesis allows for precise control over metal-organic framework structure but requires high temperature and pressure. Hydrothermal synthesis is more environmentally friendly but limited to water-stable metal-organic frameworks. Electrochemical synthesis is scalable and energy-efficient, though restricted by the types of metals and ligands. Room temperature synthesis is energy-efficient but may result in lower yield or purity. Conventional annealing is a widely used technique to control the microstructure of metal-organic framework derived materials by heating and cooling the precursor at specific temperatures. However, while annealing enhances crystallinity, thermal stability, and mechanical strength, it is energy-intensive, time-consuming, and may lead to inconsistent properties if uniform heating is not achieved.

Accordingly, one object of the present disclosure is to provide a method of forming a catalytic electrode in order to assist water splitting reactions. The method as described herein may circumvent the drawbacks and limitations, such as, high cost, low scalability, and poor environmental performance of methods and materials known in the art.

### SUMMARY

According to a first aspect, the present disclosure relates to a method of forming a catalytic electrode. The method includes depositing particles of a metal-organic framework (MOF) onto a conductive substrate to form a coated substrate, and exposing the coated substrate to a laser having a wavelength (λ) of 5 micrometer (μm) to 10 μm and a power of 25 watts (W) to 35 W to form a carbonized product. In some embodiments, the metal organic framework is at least one selected from the group consisting of a copper containing metal organic framework and a cobalt/nickel containing metal organic framework. In some embodiments, the carbonized product includes a carbon-containing porous scaffold and nanoparticles which are at least one selected from the group consisting of cobalt-nickel (Co—Ni) alloy nanoparticles and copper oxide (CuO) nanoparticles disposed on the carbon-containing porous scaffold.

In some embodiments, the copper-containing metal-organic framework is HKUST-1 and the carbonized product comprises CuO crystallites having an average diameter of from 5 to 15 nm.

In some embodiments, the cobalt/nickel-containing metal-organic framework includes cobalt (Co), nickel (Ni), and a benzenetricarboxylic acid (C₉H₆O₆) or salt thereof, and has an atomic ratio of Co:Ni of 0.5:1 to 2:1.

In some embodiments, the benzenetricarboxylic acid or salt thereof is 1,3,5-benzenetricarboxylic acid [C₆H₃(CO₂H)₃] or salt thereof.

In some embodiments, the cobalt-nickel alloy nanoparticles are CoNi nanoparticles, and the carbonized product further includes beta phase of cobalt (β-Co) nanoparticles.

In some embodiments, the Co—Ni alloy nanoparticles have a mean size of 1 nanometer (nm) to 50 nm.

In some embodiments, the copper oxide nanoparticles include CuO and Cu₂O by powder X-ray diffraction (PXRD).

In some embodiments, the copper oxide nanoparticles have a mean size of 1 nm to 50 nm.

In some embodiments, the conductive substrate is nickel foam.

In some embodiments, the metal organic framework is present on the conductive substrate at a surface density of 5 milligram per square centimeter (mg/cm²) to 25 mg/cm².

In some embodiments, the laser is a CO₂ laser having a wavelength of 10.6 μm.

In some embodiments, the laser is passed across a surface of the coated substrate at a rate of 50 millimeters per second (mm/s) to 500 mm/s.

In some embodiments, the exposing is performed in ambient atmosphere.

In some embodiments, the metal organic framework is substantially free of zinc (Zn).

In some embodiments, the depositing is performed by mixing copper nitrate (Cu(NO₃)₂) and 1,3,5-benzenetricarboxylic acid [C₆H₃(CO₂H)₃] in a solvent including ethanol and dimethylformamide (DMF) to form a reaction mixture. Further, hydrothermally treat the reaction mixture at 100° C. to 150° C. for 6 to 24 hours to form the particles of the metal organic framework, and ultrasonically treating a deposition mixture including the conductive substrate, the particles of the metal-organic framework, and ethanol (C₂H₆O) to form the coated substrate.

In some embodiments, the depositing is performed by mixing nickel nitrate (Ni(NO₃)₂), Cu(NO₃)₂, and C₆H₃(CO₂H)₃ in a solvent including DMF and CH₃COOH to form a reaction mixture. Further, hydrothermally treating the reaction mixture at 150° C. to 200° C. for 24 to 120 hours to form the particles of the metal organic framework, and ultrasonically treating a deposition mixture including the conductive substrate, the particles of the metal-organic framework, and ethanol to form the coated substrate.

The present disclosure also relates to a method of electrochemically forming oxygen. In some embodiments, the method includes forming a catalytic electrode by the above described method, and applying a potential of 0.01 volts (V) to 1.5 V to the catalytic electrode in an aqueous electrolyte solution including a hydroxide base.

In some embodiments, the aqueous electrolyte solution includes a hydroxide base is 1.0 molar (M) potassium hydroxide (KOH).

In some embodiments, the carbonized product includes Co—Ni nanoparticles, and the method has a potential required to generate a current density of 50 milliamperes per square centimeter (mAcm⁻²) (η50) of 300 millivolts (mV) to 400 mV relative to the reversible hydrogen electrode (RHE), and a Tafel slope of 60 millivolts per decade (mV/dec) to 90 mV/dec.

In some embodiments, the carbonized product includes copper oxide nanoparticles including CuO and Cu₂O, and the method has a potential required to generate a current density of 50 mAcm⁻² (η50) of 420 mV to 560 mV relative to the RHE, and a Tafel slope of 140 mV/dec to 175 mV/dec.

The foregoing general description of the illustrative embodiments and the following detailed description thereof are merely exemplary aspects of the teachings of this disclosure and are not restrictive.

### BRIEF DESCRIPTION OF DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flow chart depicting a method of forming a catalytic electrode, according to certain embodiments.

FIG. 2A shows X-ray diffraction (XRD) pattern of nickel-cobalt-benzene-1,3,5-tricarboxylic acid (NiCo BTC) metal-organic framework (MOF), according to certain embodiments.

FIG. 2B shows XRD pattern of pattern of zeolitic imidazolate framework-8 (ZIF-8), according to certain embodiments.

FIG. 2C shows XRD pattern of pattern of HKUST-1, according to certain embodiments.

FIG. 3A shows a field-emission scanning electron microscopy (FE-SEM) image of NiCo BTC, according to certain embodiments.

FIG. 3B shows a FE-SEM image of ZIF-8, according to certain embodiments.

FIG. 3C shows a FE-SEM image of HKUST-1, according to certain embodiments.

FIG. 4A shows the XRD profile of laser-annealed NiCo BTC, according to certain embodiments.

FIG. 4B shows the XRD profile of ZIF-8, according to certain embodiments.

FIG. 4C shows the XRD profile of HKUST-1, according to certain embodiments.

FIG. 5A shows a transmission electron microscopy (TEM) image of laser-annealed NiCo BTC at a magnification of 200 nanometers (nm), according to certain embodiments.

FIG. 5B shows a high-resolution transmission electron microscopy (HRTEM) image of laser-annealed NiCO BTC at a magnification of 10 nm, according to certain embodiments.

FIG. 5C shows a zoom in image of a single particle from FIG. 5B indicating lattice fringes and lattice spacing.

FIG. 5D shows a TEM image of laser-annealed ZIF-8 at a magnification of 100 nm, according to certain embodiments.

FIG. 5E shows a HRTEM image of laser-annealed ZIF-8 at a magnification of 10 nm, according to certain embodiments.

FIG. 5F shows a zoom in image of a single particle from FIG. 5E indicating lattice fringes and lattice spacing.

FIG. 5G shows a TEM image of laser-annealed HKUST-1 at a magnification of 100 nm, according to certain embodiments.

FIG. 5H shows a HRTEM image of laser-annealed HKUST-1 at a magnification of 10 nm, according to certain embodiments.

FIG. 5I shows a zoom in image of a single particle from FIG. 5H indicating lattice fringes and lattice spacing.

FIG. 6A is a graph depicting polarization curves for bare nickel foam (NF) over NF at a scan rate of 5 mVs⁻¹ in 1.0 M KOH electrolyte solution for laser annealed MOFs and thermal annealed MOFs combined, according to certain embodiments.

FIG. 6B is an enlarged graph depicting polarization curves of bare nickel foam (NF) over NF in 1.0 M KOH electrolyte, for laser annealed MOFs, according to certain embodiments.

FIG. 6C is an enlarged graph depicting polarization curves of bare nickel foam (NF) over NF in 1.0 M KOH electrolyte, for thermal annealed MOFs, according to certain embodiments.

FIG. 7 depicts a Tafel plot for bare NF over NF at a scan rate of 5 mV/s⁻¹ in 1.0 M KOH electrolyte solution for laser-annealed MOFs and thermal annealed MOFs, according to certain embodiments.

FIG. 8A is a Nyquist plot of the electrochemical impedance spectroscopy (EIS) for bare NF, and laser annealed MOFs, according to certain embodiments.

FIG. 8B shows a chronopotentiometry profile of laser-annealed NiCo BTC catalyst measured at 1.52 V vs RHE, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term ‘metal-organic framework (MOF)’ refers to the crystalline materials composed of metal ions or metal clusters (nodes) that are linked by organic molecules (ligands), forming an extended three-dimensional network. The metal ions typically serve as coordination sites for the organic ligands, which act as linkers to create a porous, rigid structure. MOFs are characterized by their high surface area, tunable pore sizes, and structural flexibility, which can be tailored by selecting different metals and ligands.

As used herein, the term ‘surface density’ refers to the amount of a property (such as mass, charge, or particle number) per unit area on a surface. It is used to quantify how much of a substance is distributed over a two-dimensional surface. Common types of surface density include mass surface density (mass per unit area), charge surface density (charge per unit area), and particle surface density (particles per unit area). Surface density is mathematically expressed as the quantity of interest divided by the surface area.

Current density is a measure of the electric current flowing per unit area of a conductor or surface, typically expressed in amperes per square meter (A/m²). It quantifies the distribution of electric charge flow in each direction across a specified area. Mathematically, current density is calculated by dividing the total current by the cross-sectional area through which the current flows.

As used herein, the term ‘conductive substrate’ refers to the material that possesses sufficient electrical conductivity, enabling the efficient flow of charge, typically used as a support for the deposition or interaction of other materials in electronic, electrochemical, or catalytic applications.

As used herein, the term ‘reversible hydrogen electrode (RHE)’ refers to the standard reference electrode used in electrochemical measurements, defined by the reversible half-reaction of hydrogen ions and hydrogen gas at an electrode surface. The electrode is typically composed of a platinum surface in contact with a solution containing H+ ions, where hydrogen gas is bubbled over the platinum.

As used herein, the term ‘carbon-containing porous scaffold’ refers to the three-dimensional material primarily composed of carbon, featuring a network of interconnected pores that provides high surface area and facilitates fluid, gas, or cell transport. The porous structure, which can be made from materials like activated carbon, carbon nanotubes, or carbonized polymers, allows for functionalization and tailoring of properties such as mechanical strength, biocompatibility, and electrical conductivity.

The Tafel slope is a parameter in electrochemistry that describes the relationship between the overpotential (extra voltage needed for a reaction to occur at a higher rate) and the current density in an electrochemical reaction. It is derived from the Tafel equation, which models the kinetics of reactions like hydrogen evolution or oxygen reduction. The Tafel slope indicates how efficiently a reaction proceeds; a lower Tafel slope means the reaction requires less overpotential for a given current density, implying higher efficiency, while a higher Tafel slope indicates lower efficiency.

Aspects of the present disclosure are directed toward metal-organic frameworks (MOFs)-based electrodes, fabricated via a laser-assisted annealing process, for water-splitting applications. The electrode of the present disclosure addresses the limitations associated with conventional water-splitting electrodes, such as sub-optimal reaction kinetics and high manufacturing costs, by enabling the creation of electrodes with superior catalytic efficiency and structural integrity. The electrodes fabricated by the method of present disclosure offer significant improvements in electrode performance, efficiency, and economic viability, thereby making them suitable for widespread application in hydrogen production technologies.

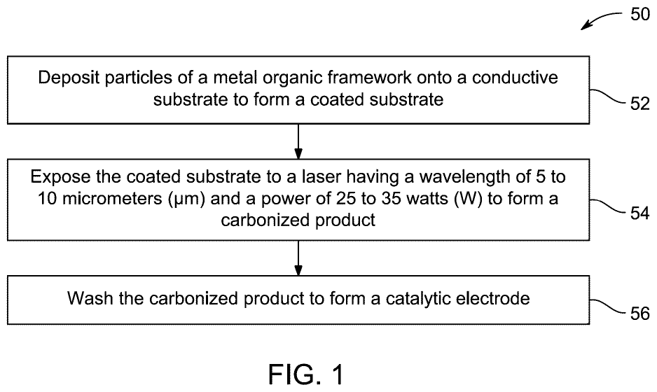

FIG. 1A illustrates a schematic flow chart of a method 50 of forming a catalytic electrode. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes depositing particles of a metal-organic framework onto a conductive substrate to form a coated substrate. T

The International Union of Pure and Applied Chemistry (IUPAC) states that a metal organic framework (MOF) is a coordination network with organic ligands containing potential voids. A coordination network is a coordination compound extending, through repeating coordination entities, in one dimension, but with cross-links between two or more individual chains, loops, or spiro-links, or a coordination compound extending through repeating coordination entities in two or three dimensions; and finally a coordination polymer is a coordination compound with repeating coordination entities extending in one, two, or three dimensions. A coordination entity is an ion or neutral molecule that is composed of a central atom, usually that of a metal, to which is attached a surrounding array of atoms or groups of atoms, each of which is called ligands. More succinctly, a metal organic framework is characterized by metal ions or clusters coordinated to organic ligands to form one-, two-, or three-dimensional structures. Typically, a metal-organic framework exhibits a regular void or pore structure. The nature of the void or pore structure, including properties or structural factors such as the geometry about the metal ions or clusters, the arrangement of the linkages between metal ions or clusters, and the number, identity, and spatial arrangement of voids or pores. These properties may be described as the structure of the repeat units and the nature of the arrangement of the repeat units. The specific structure of the metal-organic framework, which may include the void or pore structure is typically referred to as the metal-organic framework topology.

The metal-organic framework comprises a metal ion which is an ion of at least one metal selected from the group consisting of a transition metal (e.g. Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs, Mt, Ds, Rg, and Cn), a post-transition metal (e.g. Al, In, Ga, Sn, Bi, Pb, Tl, Zn, Cd, and Hg), and an alkaline earth metal (e.g. Be, Mg, Ca, Sr, Ba, and Ra). Further, these metal ions may be of any oxidation state M⁺¹, M⁺², M⁺³, etc. In one or more embodiments, the metal ion is an ion of at least one metal selected from the group consisting of Zn, Cu, Fe, Ni, Co, Mn, Cr, Cd, Mg, Ca, and Zr. In some embodiments, the metal-organic framework is at least one selected from the copper-containing metal-organic framework and a cobalt/nickel-containing metal-organic framework. In some embodiments, the metal-organic framework is substantially free of zinc.

In the formation of a metal organic framework, the organic ligands must meet certain requirements to form coordination bonds, primarily being multi-dentate, having at least two donor atoms (i.e. N−, and/or O−) and being neutral or anionic. The structure of the metal organic framework is also affected by the shape, length, and functional groups present in the organic linker. In certain embodiments, the metal organic framework of the present disclosure comprises anionic ligands as organic ligands. In general, the organic ligands can be any suitable linker, including mono-, bi-, tri-, or tetra-carboxylic acids, hydroxy-containing aromatic ligands,, nitrogen-containing heterocyclic structures, or mixed ligands containing a variety of such functional groups. For example, the organic ligands may be dicarboxylates, tricarboxylates, tetracarboxylates, bipyridines, imidazolate-based, imidazole-derived or ligands similar to an imidazole including, but not limited to, optionally substituted imidazoles, optionally substituted benzimidazoles, optionally substituted imidazolines, optionally substituted pyrazoles, optionally substituted thiazoles, and optionally substituted triazoles.

Suitable examples of the copper-containing metal organic framework may include, but is not limited to, HKUST-1 (Cu-BTC), Cu-MOF-74, Cu-MOF-5, Cu-BDC, Cu-2,5-DHT, Cu-TPA, Cu-BTC-2, Cu-MOF-199, Cu-CPO-27, Cu-IRMOF-3, Cu-IRMOF-10, Cu-MOF-74-NH2, Cu-MOF-74-COOH, Cu-MOF-12, Cu-TCPP, Cu-MOF-74-M, Cu-MOF-76, Cu-MOF-10, Cu-MOF-53, Cu-MOF-61, Cu-IRMOF-4, Cu-BTB, Cu-MOF-100, Cu-MOF-101, Cu-MOF-106, Cu-MOF-107, Cu-CAU-1, Cu-CAU-10, Cu-BHT, Cu-BDC-NH2, Cu-MOF-54, Cu-MOF-11, Cu-MOF-3, Cu-BPDC, Cu-MOF-8, Cu-MOF-1, Cu-1,4-BDC, Cu-BPY, Cu-1,3,5-BTC, Cu-MOF-107-NH2, Cu-MOF-9, Cu-PMOF, Cu-Ni-MOF, Cu-SBA-15, Cu-MOF-70, Cu-MOF-15, Cu-MOF-56, Cu-MOF-60, Cu-MOF-69, Cu-MOF-66, Cu-CMOF, Cu-BiT-2, Cu-PIC, Cu-MOF-71, Cu-MOF-28, Cu-IRMOF-8, Cu-HPVDC, Cu-CNMOF, Cu-COF, Cu-TMA, Cu-OMOF, Cu-4,4'-BPDC, Cu-SO3, Cu-MOF-38, Cu-CF-1, Cu-MOF-42, Cu-MOF-5, Cu-BEA, Cu-MOF-48, Cu-CPO-30, Cu-MOF-49, Cu-CTF, Cu-MOF-39, Cu-MOF-4, Cu-BTDA, Cu-MOF-33, Cu-MOF-17, Cu-1,4-DHT, Cu-BBA, Cu-MOF-41, Cu-NH2-MOF, Cu-MOF-30, Cu-1,2,4-BDC, Cu-1,2,5-BDC, Cu-PVA-MOF, Cu-BDP, Cu-CTC, Cu-MOF-71-NH2, Cu-CBC, Cu-CT-MOF, Cu-MOF-78, Cu-DEF, Cu-IMOF, Cu-TDA, Cu-MOF-110, Cu-Pyrazole-MOF, Cu-TPA-BTC, Cu-MOF-43, Cu-2,6-BDC, Cu-MOF-29, Cu-MOF-53, Cu-MOF-62, Cu-MOF-75, Cu-MOF-80, Cu-BTC-6, Cu-MOF-20, Cu-MOF-85, Cu-TCB, Cu-MOF-36, Cu-NH2-MOF-74, Cu-SBDC, Cu-BPI, Cu-PyC, Cu-CCL-MOF, Cu-CO2-MOF, Cu-MOF-77, Cu-2-MPC, Cu-MOF-91, Cu-COOH-MOF, Cu-BSDA, Cu-MOF-95, Cu-MOF-89, Cu-CPD, Cu-MOF-79, Cu-MOF-23, Cu-MOF-48-X, Cu-PO4, Cu-MOF-72, Cu-MOF-63, Cu-BMA, Cu-3,5-DHT, Cu-COD, Cu-MOF-82, Cu-BPD, Cu-2-MOF, Cu-TM-BDC, Cu-CO3, Cu-PVC-MOF, Cu-MOF-40, Cu-MOF-50, Cu-TPA-MOF, Cu-ABDC, Cu-DCBDC, Cu-MOF-98, Cu-ACMOF, Cu-MOF-51, Cu-PAA-MOF, Cu-TM-MOF, Cu-BTDA-MOF, Cu-MOF-110-NH2, Cu-PhD, Cu-CMA, Cu-MOF-42-NH2, Cu-MOF-67, Cu-MOF-52, Cu-MOF-84, Cu-BEA-1, Cu-PPy, Cu-MOF-111, Cu-BTF, Cu-MOF-109, Cu-MOF-73, Cu-MOF-88, Cu-MOF-92, Cu-CMOF-29, Cu-MOF-104, Cu-MOF-108, Cu-PBD-MOF, Cu-MOF-114, Cu-MOF-115, Cu-TCPP-MOF, Cu-MOF-79-X, Cu-TMA-BDC, Cu-MOF-117, Cu-MOF-116, Cu-PDB-MOF, Cu-2,4-BDC, Cu-MOF-123, Cu-MOF-120, Cu-MOF-119, Cu-PBO, Cu-Ph-Py-MOF, Cu-MOF-124, Cu-PVA, Cu-MOF-113, Cu-BPDC-2, Cu-BTF, Cu-IMID, Cu-MOF-122, Cu-MOF-118, Cu-DBDC, Cu-TC-MOF, Cu-CT-Py, Cu-MOF-129, Cu-MOF-130, Cu-MOF-135, Cu-MOF-131, Cu-MOF-136, Cu-MOF-140, Cu-Pt-MOF, Cu-MOF-151, Cu-MOF-152, Cu-MOF-153, Cu-MOF-154, Cu-DEF-MOF, Cu-MOF-155, Cu-TPA-2-BDC, Cu-MOF-156, Cu-MOF-157, Cu-MOF-158, Cu-MOF-159, Cu-TCA-MOF, Cu-2-BPA, Cu-MOF-160, Cu-MOF-161, Cu-MOF-162, Cu-MOF-163, Cu-MOF-164, Cu-MOF-165, Cu-MOF-166, Cu-MOF-167, Cu-MOF-168, Cu-MOF-169, Cu-MOF-170, Cu-MOF-171, Cu-MOF-172, Cu-BDC-MOF, Cu-MOF-173, Cu-BAB, Cu-MOF-174, Cu-MOF-175, Cu-MOF-176, Cu-MOF-177, Cu-1,3-DCA, Cu-MOF-178, Cu-TPA-TC, Cu-MOF-179, Cu-MOF-180, Cu-PPDC, Cu-MOF-181, Cu-MOF-182, Cu-MOF-183, Cu-MOF-184, Cu-MOF-185, Cu-MOF-186, Cu-MOF-187, Cu-MOF-188, Cu-MOF-189, Cu-MOF-190, Cu-MOF-191, Cu-MOF-192, Cu-MOF-193, Cu-MOF-194, Cu-1,2,4-TDA, Cu-MOF-195, Cu-MOF-196, Cu-MOF-197, Cu-MOF-198, Cu-MOF-199, Cu-MOF-200, Cu-MOF-201, Cu-BPDC-MOF, Cu-MOF-202, Cu-MOF-203, Cu-MOF-204, Cu-MOF-205, Cu-MOF-206, Cu-MOF-207, Cu-MOF-208, Cu-MOF-209, Cu-MOF-210, Cu-MOF-211, Cu-MOF-212, Cu-MOF-213, Cu-MOF-214, Cu-MOF-215, Cu-MOF-216, Cu-MOF-217, Cu-MOF-218, Cu-MOF-219, Cu-MOF-220, Cu-MOF-221, Cu-MOF-222, Cu-MOF-223, Cu-MOF-224, Cu-MOF-225, Cu-MOF-226, Cu-MOF-227, Cu-MOF-228, Cu-MOF-229, Cu-MOF-230, Cu-MOF-231, Cu-MOF-232, Cu-MOF-233, Cu-MOF-234, Cu-MOF-235, Cu-MOF-236, Cu-MOF-237, Cu-MOF-238, Cu-MOF-239, Cu-MOF-240, Cu-MOF-241, Cu-MOF-242, Cu-MOF-243, Cu-MOF-244, Cu-MOF-245, Cu-MOF-246, Cu-MOF-247, Cu-MOF-248, Cu-MOF-249, Cu-MOF-250, Cu-MOF-251, Cu-MOF-252, Cu-MOF-253, Cu-MOF-254, Cu-MOF-255, Cu-MOF-256, Cu-MOF-257, Cu-MOF-258, Cu-MOF-259, Cu-MOF-260, Cu-MOF-261, Cu-MOF-262, Cu-MOF-263, Cu-MOF-264, Cu-MOF-265, Cu-MOF-266, Cu-MOF-267, Cu-MOF-268, Cu-MOF-269, Cu-MOF-270, Cu-MOF-271, Cu-MOF-272, Cu-MOF-273, Cu-MOF-274, Cu-MOF-275, Cu-MOF-276, Cu-MOF-277, Cu-MOF-278, Cu-MOF-279, Cu-MOF-280, Cu-MOF-281, Cu-MOF-282, Cu-MOF-283, Cu-MOF-284, Cu-MOF-285, Cu-MOF-286, Cu-MOF-287, Cu-MOF-288, Cu-MOF-289, Cu-MOF-290, Cu-MOF-291, Cu-MOF-292, Cu-MOF-293, Cu-MOF-294, Cu-MOF-295, Cu-MOF-296, Cu-MOF-297, Cu-MOF-298, Cu-MOF-299, Cu-MOF-300, Cu-MOF-301, Cu-MOF-302, Cu-MOF-303, Cu-MOF-304, Cu-MOF-305, Cu-MOF-306, Cu-MOF-307, Cu-MOF-308, Cu-MOF-309, Cu-MOF-310, Cu-MOF-311, Cu-MOF-312, Cu-MOF-313, Cu-MOF-314, Cu-MOF-315, Cu-MOF-316, Cu-MOF-317, Cu-MOF-318, Cu-MOF-319, Cu-MOF-320, Cu-MOF-321, Cu-MOF-322, Cu-MOF-323, Cu-MOF-324, Cu-MOF-325, Cu-MOF-326, Cu-MOF-327, Cu-MOF-328, Cu-MOF-329, Cu-MOF-330, Cu-MOF-331, Cu-MOF-332, Cu-MOF-333, Cu-MOF-334, Cu-MOF-335, Cu-MOF-336, Cu-MOF-337, Cu-MOF-338, Cu-MOF-339, Cu-MOF-340, Cu-MOF-341, Cu-MOF-342, Cu-MOF-343, Cu-MOF-344, Cu-MOF-345, Cu-MOF-346, Cu-MOF-347, Cu-MOF-348, Cu-MOF-349, Cu-MOF-350, Cu-MOF-351, Cu-MOF-352, Cu-MOF-353, Cu-MOF-354, Cu-MOF-355, Cu-MOF-356, Cu-MOF-357, Cu-MOF-358, Cu-MOF-359, Cu-MOF-360, Cu-MOF-361, Cu-MOF-362, Cu-MOF-363, Cu-MOF-364, Cu-MOF-365, Cu-MOF-366, Cu-MOF-367, Cu-MOF-368, Cu-MOF-369, Cu-MOF-370, Cu-MOF-371, Cu-MOF-372, Cu-MOF-373, Cu-MOF-374, Cu-MOF-375, Cu-MOF-376, Cu-MOF-377, Cu-MOF-378, Cu-MOF-379, Cu-MOF-380, Cu-MOF-381, Cu-MOF-382, Cu-MOF-383, Cu-MOF-384, Cu-MOF-385, Cu-MOF-386, Cu-MOF-387, Cu-MOF-388, Cu-MOF-389, Cu-MOF-390, Cu-MOF-391, Cu-MOF-392, Cu-MOF-393, Cu-MOF-394, Cu-MOF-395, Cu-MOF-396, Cu-MOF-397, Cu-MOF-398, Cu-MOF-399, Cu-MOF-400, Cu-MOF-401, Cu-MOF-402, Cu-MOF-403, Cu-MOF-404, Cu-MOF-405, Cu-MOF-406, Cu-MOF-407, Cu-MOF-408, Cu-MOF-409, Cu-MOF-410, Cu-MOF-411, Cu-MOF-412, Cu-MOF-413, Cu-MOF-414, Cu-MOF-415, Cu-MOF-416, Cu-MOF-417, Cu-MOF-418. In some embodiments, the copper-containing metal-organic framework is HKUST-1.

The cobalt/nickel-containing metal-organic framework includes cobalt and nickel. In some embodiments, the cobalt/nickel-containing metal-organic framework includes an aromatic tricarboxylic acid or salt thereof. In some embodiments, the cobalt/nickel-containing metal-organic framework has an atomic ratio of cobalt to nickel of 0.5:1 to 2:1, preferably 0.75:1 to 1.5:1, preferably 1.1:1 to 1.25:1, preferably 1:1. Examples of suitable aromatic tricarboxylic acids include, but are not limited to trimesic acid, 1,3,5-Tris(4′-carboxy[1,1′-biphenyl]-4-yl)benzene, 2,4,6-Tris-(p-carboxyphenyl)pyrdine, [1,1′:3′,1″-terphenyl]-4,4″,5′-tricarboxylic acid, (3,5-dicarboxylphenyl)-(4-(2′-carboxylphenyl)benzyl) ether, phenol tricarboxylic acid, (5′-(4-carboxyphenyl)-[1,1′:3′,1″-terphenyl]-3,4″,5-tricarboxylic acid, and the like. In some embodiments, benzenetricarboxylic acid or salt thereof is 1,3,5-benzenetricarboxylic acid or a salt thereof. In some embodiments, the cobalt/nickel-containing metal-organic framework may include Co-BTC, Ni-BTC, Co-MOF-74, Ni-MOF-74, Co-ZIF-67, Ni-ZIF-67, Co-UiO-66, Ni-UiO-66, Co-MOF-5, Ni-MOF-5, Co-CAT-1, Ni-CAT-1, Co-TCPP, Ni-TCPP, Co-MOF-74-CO₂, Ni-MOF-74-CO₂, Co-bipyridine, Ni-bipyridine, Co-SBDC, Ni-SBDC, Co-BDC, Ni-BDC, Co-FT-1, Ni-FT-1, Co-HKUST-1, Ni-HKUST-1, Co-IRMOF-3, Ni-IRMOF-3, Co—Fe-BDC, Ni—Fe-BDC, Co-ZIF-8, Ni-ZIF-8, Co-PMOF, Ni-PMOF, Co-Bipyridyl, Ni-Bipyridyl, Co-NU-1000, Ni-NU-1000, Co-IRMOF-10, Ni-IRMOF-10. In some embodiments, the cobalt/nickel-containing metal-organic framework is CoNi-BTC.

Metal organic frameworks comprising such imidazole or benzimidazole ligands are typically referred to as zeolitic imidazolate frameworks. In some embodiments, the metal organic framework is a zeolitic imidazolate framework. Examples of zeolitic imidazolate frameworks (ZIFs) include, but are not limited to ZIF-1, ZIF-2, ZIF-3, ZIF-4, ZIF-5, ZIF-6, ZIF-7, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, and ZIF-725. In some embodiments, the metal-organic framework comprises ZIF-8. In some embodiments, the metal-organic framework is ZIF-8.

In some embodiments, the metal-organic framework is present as particles. In general, the metal-organic framework particles can be any shape known to one of ordinary skill in the art. Examples of suitable shapes the metal-organic framework particles may take include spheres, spheroids, lentoids, ovoids, solid polyhedra such as tetrahedra, cubes, octahedra, icosahedra, dodecahedra, hollow polyhedra (also known as microcages or nanocages), stellated polyhedra (both regular and irregular, also known as microstars or nanostars), triangular prisms (also known as nanotriangles), hollow spherical shells (also known as microshells or nanoshells), tubes (also known as microtubes or nanotubes), sheets, microsheets, nanosheets, platelets, microplatelets, nanoplatelets, disks, microdisks, nanodisks, rods (also known as microrods or nanorods), and mixtures thereof. In the case of microrods or nanorods, the rod shape may be defined by a ratio of a rod length to a rod width, the ratio being known as the aspect ratio. For metal-organic framework particles of the current invention, microrods or nanorods should have an aspect ratio less than 1000, preferably less than 750, preferably less than 500, preferably less than 250, preferably less than 100, preferably less than 75, preferably less than 50, preferably less than 25.

In some embodiments, the metal-organic framework particles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of metal-organic framework particles having a different shape. As used herein, the term “non-uniform shape” refers to an average consistent shape that differs by more than 10% of the distribution of metal-organic framework particles having a different shape. In one embodiment, the shape is uniform and at least 90% of the metal-organic framework particles are spherical or substantially circular, and less than 10% are polygonal. In another embodiment, the shape is non-uniform and less than 90% of the metal-organic framework particles are spherical or substantially circular, and greater than 10% are polygonal.

In some embodiments, the metal-organic framework particles have a mean particle size of 5 nm to 10 μm. For example the metal-organic framework particles can have a mean particle size of 10 nm, 15 nm, 20 nm, 25 nm, 50 nm, 75 nm, 100 nm, 150 nm, 200 nm, 250 nm, 300 nm, 350 nm, 400 nm, 450 nm, 500 nm, 600 nm, 700 nm, 800 nm, 900 nm, 1000 nm, 1250 nm, 1500 nm, 1750 nm, 2.0 μm, 2.25 μm, 2.5 μm, 2.75 μm, 3.0 μm, 3.25 μm, 3.5 μm, 3.75 μm, 4.0 μm, 4.25 μm, 4.5 μm, 4.75 μm, 5.0 μm, 5.5 μm, 6.0 μm, 6.5 μm, 7.0 μm, 7.5 μm, 8.0 μm, 8.5 μm, 9.0 μm, 9.5 μm, or 10 μm. In embodiments where the metal-organic framework particles are spherical, the particle size may refer to a particle diameter. In embodiments where the metal-organic framework particles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the metal-organic framework particles have an anisotropic shape such as microrods or nanorods, the particle size may refer to a length of the microrod or nanorod, a width of the microrod or nanorod, or an average of the length and width of the microrod or nanorod. In some embodiments in which the metal-organic framework particles have non-spherical shapes, the particle size may refer to the diameter of a sphere having an equivalent volume as the particle. In some embodiments in which the metal-organic framework particles have non-spherical shapes, the particle size refer may to the diameter of a sphere having an equivalent diffusion coefficient as the particle.

In some embodiments, the metal-organic framework particles of the present disclosure are monodisperse, having a coefficient of variation or relative standard deviation, expressed as a percentage and defined as the ratio of the particle size standard deviation (σ) to the particle size mean ( μ) multiplied by 100 of less than 25%, preferably less than 10%, preferably less than 8%, preferably less than 6%, preferably less than 5%, preferably less than 4%, preferably less than 3%, preferably less than 2%. In some embodiments, the metal-organic framework particles of the present disclosure are monodisperse having a particle size distribution ranging from 80% of the average particle size to 120% of the average particle size, preferably 90-110%, preferably 95-105% of the average particle size. In some embodiments, the metal-organic framework particles are not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

In some embodiments, particles of the metal-organic framework are deposited onto the conductive substrate to form the coated substrate. In some embodiments, the substrate may be made from materials such as copper, aluminum, nickel, iron, and steel. In some embodiments, the steel substrate may include, but is not limited to, stainless steel, crucible steel, carbon steel, spring steel, alloy steel, maraging steel, weathering steel, tool steel, or any combination thereof. In some embodiments, the steel substrate may be a steel mesh substrate. In some embodiments, the conductive substrate is nickel foam.

In some embodiments, the substrate may be transparent. In some embodiments, the transparent substrate is a glass substrate. In some embodiments, the glass substrate is at least one selected from the group consisting of a fluorine-doped tin oxide (FTO) coated glass substrate, a tin-doped indium oxide (ITO) coated glass substrate, an aluminum doped zinc oxide (AZO) coated glass substrate, a niobium doped titanium dioxide (NTO) coated glass substrate, an indium doped cadmium oxide (ICO) coated glass substrate, an indium doped zinc oxide (IZO) coated glass substrate, a fluorine-doped zinc oxide (FZO) coated glass substrate, a gallium doped zinc oxide (GZO) coated glass substrate, an antimony doped tin oxide (ATO) coated glass substrate, a phosphorus-doped tin oxide (PTO) coated glass substrate, a zinc antimonate coated glass substrate, a zinc oxide coated glass substrate, a ruthenium oxide coated glass substrate, a rhenium oxide coated glass substrate, a silver oxide coated glass substrate, and a nickel oxide coated glass substrate. In some embodiments, elements such as Ni, Al, Cu, Fe, Ag, Zn, Sn, Sb, Ti, In, V, Cr, Co, C, Ca, Mo, Au, P, W, Rh, Mn, B, Si Ge, Se, Ln, Ga, Ir, and an alloy or a mixture of two or more of the substance, may be disposed on the surface of the transparent substrate.

In some embodiments, the particles of the metal-organic framework may substantially cover the substrate, whereby the % surface area coverage of the substrate that is covered with the metal-organic framework is at least 75%, at least 80%, at least 85%, at least 90%, at least 95%, at least 96%, at least 97%, at least 98%, at least 99%. In some embodiments, the metal-organic framework may incompletely cover, or only cover a portion or portions of the substrate, whereby the % surface area coverage of the substrate that is covered with the metal-organic framework is less than 75%, less than 65%, less than 60%, less than 55%, less than 50%, less than 45%, less than 40%, less than 35%, less than 30%, less than 25%, less than 20%, less than 15%, less than 10%. In some embodiments, the entire substrate and, therefore, the surface of the substrate is made of the metal-organic framework.

In some embodiments, the particles of the metal-organic framework are deposited onto the conductive substrate to form the coated substrate using one of the techniques such as physical vapor deposition (PVD), chemical vapor deposition (CVD), spin coating, dip coating, electrophoretic deposition (EPD), langmuir-blodgett (LB) technique, drop casting, sol-gel process, layer-by-layer (LbL) assembly, inkjet printing, spray coating, and ultrasonic spray deposition. In some embodiments, the particles of the metal-organic framework are deposited onto the conductive substrate to form the coated substrate using the drop-casting technique, preferably ultrasonic vibration-assisted drop-casting (SVADC). Exemplary steps for depositing the particles of the metal-organic framework on the conductive substrate are explained below.

In some embodiments, the particles of the copper-containing metal-organic framework (e.g., HKUST-1), are prepared by mixing copper nitrate and 1,3,5-benzenetricarboxylic acid in a solvent including ethanol and dimethylformamide to form a reaction mixture. Suitable examples of other solvents that can be used may include, but are not limited to, water, methanol, ethanol, n-propanol, isopropanol, n-butanol, isobutanol, tert-butanol, ethyl acetate and other lower alkanols, glycerine, acetone, dichloromethane (DCM), dimethyl sulfoxide (DMSO), dimethyl acetate (DMA), dimethylformamide (DMF), isopropyl ether, acetonitrile, toluene, N-methyl pyrrolidone (NMP), tetrahydrofuran (THF), tetrahydropyran, other cyclic mono-, di- and tri-ethers, polyalkylene glycols (e.g., polyethylene glycol, polypropylene glycol, propylene glycol), and mixtures thereof in suitable proportions. In some embodiments, the reaction mixture is subjected to hydrothermal treatment at 100 to 150° C., preferably 105 to 140° C., preferably 110 to 130° C., preferably 115 to 125° C., preferably 120° C., for 6 to 24 hours, preferably 8 to 20 hours, preferably 10 to 16 hours, preferably 12 hours to form the particles of the copper-containing metal-organic framework. In some embodiments, the particles of the copper-containing metal-organic framework are deposited onto the conductive substrate, preferably via the SVADC technique, although other methods may be adopted. In some embodiments, the particles of the metal-organic framework are dissolved in a suitable solvent, preferably ethanol. In some embodiments, a deposition mixture including the conductive substrate, the particles of the metal-organic framework, and ethanol are subjected to ultrasonic treatment to form the coated substrate.

In some embodiments, the particles of the cobalt/nickel-containing metal-organic framework are prepared by mixing nickel nitrate, copper nitrate, and 1,3,5-benzenetricarboxylic acid in a solvent including dimethylformamide and acetic acid to form a reaction mixture. In some embodiments, the reaction mixture is subjected to hydrothermal treatment at 150 to 200° C., preferably 160 to 180° C., preferably 170 to 175° C. for 24 to 120 hours, 60 to 80 hours, 72 hours to form the particles of the cobalt/nickel-containing metal-organic framework. In some embodiments, the particles of the cobalt/nickel-containing metal-organic framework are deposited onto the conductive substrate, preferably via the SVADC technique, although other methods may be adopted. In this method, the particles of the cobalt/nickel-containing metal-organic framework are dissolved in a suitable solvent, preferably ethanol. In some embodiments, a deposition mixture including the conductive substrate, the particles of the metal-organic framework, and ethanol are subjected to ultrasonic treatment to form the coated substrate.

At step 54, the method 50 includes exposing the coated substrate to a laser having a wavelength of 5 to 10 micrometers ( μm) and a power of 25 to 35 watts (W), more preferably 28 to 32 W, and yet more preferably 30 W to form a carbonized product. Examples of suitable lasers which may be used include, but are not limited to, helium-neon lasers, argon lasers, krypton lasers, xenon ion lasers, nitrogen lasers, carbon dioxide (CO₂) lasers, carbon monoxide lasers, excimer lasers, hydrogen fluoride lasers, deuterium fluoride lasers, chemical oxygen-iodine lasers, all gas-phase iodine lasers, dye lasers, ruby laser, yttrium-CoNi nanoparticles aluminum-garnet (YAG) lasers (e.g. YAG and any of Nd, Cr, Er, Y, Ca, glass, Th, Yb, Ho), and the like.

In some embodiments, the laser is a CO₂ laser. In some embodiments, the CO₂ laser produces a laser beam of infrared light having an operation wavelength of 8.0-12.0 μm, preferably 8.5-11.5 μm, preferably 9.0-11.0 μm, preferably 9.4-10.6 μm, preferably 10.6 μm. In some embodiments, the CO₂ laser is powered by a traverse pump (high power). In some embodiments, the CO₂ laser is powered by a longitudinal electrical discharge pump (low power). In some embodiments, the CO₂ laser may also have an efficiency rating, as defined by the ratio of output power to pump power, of up to 25%, preferably up to 22%, preferably up to 20%, preferably up to 18%, or up to 16%. In some embodiments, the laser is passed across a surface of the coated substrate at a rate of 50 to 500 millimeters per second (mm/s), preferably 80 to 120 mm/s, preferably 100 mm/s. In some embodiments, the the coated substrate is exposed to the laser in an ambient atmosphere.

At step 56, the method 50 includes washing the carbonized product to form the catalytic electrode. In some embodiments, the carbonized product may be washed with water, hydrochloric acid, nitric acid, sulfuric acid, sodium hydroxide, potassium hydroxide, ethanol, methanol, isopropanol, acetone, dimethyl sulfoxide, toluene, xylene, hydrogen peroxide, chloroform. In some embodiments, the carbonized product may be washed with DMF and methanol.

In some embodiments, the carbonized product includes a carbon-containing porous scaffold and nanoparticles disposed on the carbon-containing porous scaffold.

In some embodiments, the carbon-containing porous scaffold includes a porous network of carbon. In general, such a porous network can have any suitable structure or form. The porous network may have macropores, mesopores, micropores, or any other types of pores or combinations thereof. In some embodiments, the porous network comprises open pores. A network that comprises open pores may be referred to as an “open cell network” or other similar term. Open pores are pores that have solid edges and open faces, and fluid flow is possible to penetrate among them. This type of pore is in contrast to closed pores which form a “closed cell network”. Closed pores are pores that are connected via solid faces with no interconnectivity among them. In some embodiments, the porous network further comprises closed pores. Open pores may be advantageous for increasing a catalytically active surface area. Open pores may allow for flow of gases and/or liquids into the network such that gases and/or liquids can contact interior surfaces of interior pores.

In general, the network of pores may be ordered or disordered. An ordered network of pores refers to a network having a regular or periodic arrangement of pores that repeats throughout the network. Ordered networks of pores typically have relatively uniform pore sizes. A disordered network of pores refers to a network lacking a regular or periodic arrangement of pores. In a disordered network of pores, pores may be randomly arranged. Disordered networks of pores may be regular pore sizes, irregular pore sizes, or regions of regular pore sizes and regions of irregular pore sizes. In some embodiments, the porous network of pores is ordered. In some embodiments, the porous network of pores is disordered.

In some embodiments, the carbon-containing porous scaffold comprises carbon. In some embodiments, carbon is present in an amount of at least 50 wt. %, preferably at least 55wt. %, preferably at least 60 wt. %, preferably at least 65 wt. %, preferably at least 70 wt. %, preferably at least 75 wt. %, preferably at least 80 wt. %, preferably at least 82.5 wt. %, preferably at least 85 wt. %, based on a total weight of carbon-containing scaffold. In some embodiments, the carbon-containing porous scaffold can also include another element, such as oxygen, sulfur, nitrogen, or combinations of these. In general, the oxygen, sulfur, and nitrogen may each independently be present in the form of isolated atoms or ions, clusters of atoms or ions, and/or present as complexes or groups comprising the element. For example, oxygen may be present as isolated oxygen dopant atoms in the carbon that makes up the carbon-containing porous scaffold, as isolated oxygen ions present in the carbon that makes up the carbon-containing porous scaffold, as atomic oxygen or an oxygen-containing gas such as water vapor, carbon monoxide, carbon dioxide, or the like present on a surface of pores or trapped within pores, as a component of an oxygen-containing functional group such as carbonyl, hydroxyl, carboxyl, ether, ester, and the like, or combinations of these. In some embodiments, a portion of the oxygen is present as isolated oxygen dopant atoms in the carbon that makes up the carbon-containing porous scaffold and/or as isolated oxygen ions present in the carbon that makes up the carbon-containing porous scaffold. Similarly, nitrogen may be present as isolated nitrogen dopant atoms in the carbon that makes up the carbon-containing porous scaffold, as isolated nitrogen ions present in the carbon that makes up the carbon-containing porous scaffold, as atomic nitrogen or a nitrogen-containing gas such as ammonia, nitric oxide, nitrogen dioxide, and the like present on a surface of pores or trapped within pores, as a component of a nitrogen-containing functional group such as a amide, amidine, amine, imine, imide, azide, cyanate, nitrate, nitrile, nitro, and the like, or combinations of these. In some embodiments, a portion of the nitrogen is present as isolated nitrogen dopant atoms in the carbon that makes up the carbon-containing porous scaffold and/or as isolated nitrogen ions present in the carbon that makes up the carbon-containing porous scaffold. Sulfur may be present as isolated sulfur dopant atoms in the carbon that makes up the carbon-containing porous scaffold, as isolated sulfur ions present in the carbon that makes up the carbon-containing porous scaffold, as atomic sulfur or a sulfur-containing gas such as sulfur dioxide, hydrogen sulfide, dimethyl sulfide, and the like present on a surface of pores or trapped within pores, as a component of a sulfur-containing functional group such as thiol, sulfide, disulfide, sulfoxide, sulfone, sulfinic acid, sulfonic acid, thiocyanate, thioketone, thiocarboxylic acid, thioester, and the like, or combinations of these. In some embodiments, a portion of the sulfur is present as isolated sulfur dopant atoms in the carbon that makes up the carbon-containing porous scaffold and/or as isolated sulfur ions present in the carbon that makes up the carbon-containing porous scaffold.

In some embodiments, the carbon-containing porous scaffold exists as particles. Such particles of the carbon-containing porous scaffold may be separate from the metal-organic framework particles. In general, the particles of a carbon-containing porous scaffold can be any shape known to one of ordinary skill in the art. Examples of suitable shapes the particles of a carbon-containing porous scaffold may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. For particles of a carbon-containing porous scaffold of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the particles of a carbon-containing porous scaffold have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of particles of a carbon-containing porous scaffold having a different shape. As used herein, the term “non-uniform shape” refers to an average consistent shape that differs by more than 10% of the distribution of particles of a carbon-containing porous scaffold having a different shape. In one embodiment, the shape is uniform and at least 90% of the particles of a carbon-containing porous scaffold are spherical or substantially circular, and less than 10% are polygonal. In another embodiment, the shape is non-uniform and less than 90% of the particles of a carbon-containing porous scaffold are spherical or substantially circular, and greater than 10% are polygonal.

In some embodiments, the particles of a carbon-containing porous scaffold have a mean particle size of 0.1 to 1000 μm, preferably 0.5 to 750 μm, preferably 1.0 to 600 μm, preferably 5 to 500 μm, preferably 10 to 400 μm, preferably 15 to 350 μm, preferably about 20 to 300 μm. In embodiments where the particles of a carbon-containing porous scaffold are spherical, the particle size may refer to a particle diameter. In embodiments where the particles of a carbon-containing porous scaffold are polyhedral, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the particles of a carbon-containing porous scaffold have an anisotropic shape such as nanorods, the particle size may refer to a length of the nanorod, a width of the nanorod, an average of the length and width of the nanorod. In some embodiments in which the particles of a carbon-containing porous scaffold have non-spherical shapes, the particle size refers to the diameter of a sphere having an equivalent volume as the particle. In some embodiments in which the particles of a carbon-containing porous scaffold have non-spherical shapes, the particle size refers to the diameter of a sphere having an equivalent diffusion coefficient as the particle.

In some embodiments, the particles of a carbon-containing porous scaffold of the present disclosure are monodisperse, having a coefficient of variation or relative standard deviation, expressed as a percentage and defined as the ratio of the particle size standard deviation (σ) to the particle size mean ( μ) multiplied by 100 of less than 25%, preferably less than 10%, preferably less than 8%, preferably less than 6%, preferably less than 5%, preferably less than 4%, preferably less than 3%, preferably less than 2%. In some embodiments, the particles of a carbon-containing porous scaffold of the present disclosure are monodisperse having a particle size distribution ranging from 80% of the average particle size to 120% of the average particle size, preferably 90-110%, preferably 95-105% of the average particle size. In some embodiments, the particles of a carbon-containing porous scaffold are not monodisperse.

In some embodiments, the carbon-containing porous scaffold includes a carbon nanomaterial. In general, the carbon nanomaterial may be any suitable carbon nanomaterial known to one of ordinary skill in the art. Examples of carbon nanomaterials include carbon nanotubes, carbon nanobuds, carbon nanoscrolls, carbon dots, activated carbon, carbon black, graphene, graphene oxide, reduced graphene oxide, and nanodiamonds. In some embodiments, the carbon nanomaterial is at least one selected from the group consisting of graphene, graphene oxide, reduced graphene oxide, carbon nanotubes, carbon dots, and activated carbon.

In some embodiments, the carbon nanomaterial is carbon nanotubes. The carbon nanotubes may, in general, be any suitable carbon nanotubes known to one of ordinary skill in the art. Carbon nanotubes may be classified by structural properties such as the number of walls or the geometric configuration of the atoms that make up the nanotube. Classified by their number of walls, the carbon nanotubes can be single-walled carbon nanotubes (SWCNT) which have only one layer of carbon atoms arranged into a tube, or multi-walled carbon nanotubes (MWCNT), which have more than one single-layer tube of carbon atoms arranged so as to be nested, one tube inside another, each tube sharing a common orientation. Closely related to MWNTs are carbon nanoscrolls. Carbon nanoscrolls are structures similar in shape to a MWCNT but made of a single layer of carbon atoms that has been rolled onto itself to form a multi-layered tube with a free outer edge on the exterior of the nanoscroll and a free inner edge on the interior of the scroll and open ends. The end-on view of a carbon nanoscroll has a spiral-like shape. For the purposes of this disclosure, carbon nanoscrolls are considered a type of MWCNT. Classified by the geometric configuration of the atoms that make up the nanotube, carbon nanotubes can be described by a pair of integer indices n and m. The indices n and m denote the number of unit vectors along two directions in the honeycomb crystal lattice of a single layer of carbon atoms. If m=0, the nanotubes are called zigzag type nanotubes. If n=m, the nanotubes are called armchair type nanotubes. Otherwise, they are called chiral type nanotubes. In some embodiments, the carbon nanotubes are metallic. In other embodiments, the carbon nanotubes are semiconducting. In some embodiments, the carbon nanotubes are SWCNTs. In other embodiments, the carbon nanotubes are MWCNTs. In some embodiments, the carbon nanotubes are carbon nanoscrolls. In some embodiments, the carbon nanotubes are zigzag type nanotubes. In some embodiments, the carbon nanotubes are armchair type nanotubes. In other embodiments, the carbon nanotubes are chiral type nanotubes.

In some embodiments, the carbon nanomaterial is graphene. In some embodiments, the carbon nanomaterial is graphene nanosheets. Graphene nanosheets may consist of stacks of graphene sheets, the stacks having an average thickness and a diameter. In some embodiments, the stacks comprise 1 to 60 sheets of graphene, preferably 2 to 55 sheets of graphene, preferably 3 to 50 sheets of graphene.

In some embodiments, the graphene is in the form of graphene particles. The graphene particles may have a spherical shape, or may be shaped like blocks, flakes, ribbons, discs, granules, platelets, angular chunks, rectangular prisms, or some other shape. In some embodiments, the graphene particles may be substantially spherical, meaning that the distance from the graphene particle centroid (center of mass) to anywhere on the graphene outer surface varies by less than 30%, preferably by less than 20%, more preferably by less than 10% of the average distance. In some embodiments, the graphene particles may be in the form of agglomerates.

In some embodiments, the graphene is pristine graphene. Pristine graphene refers to graphene that has not been oxidized or otherwise functionalized. Pristine graphene may be obtained by methods such as exfoliation, chemical vapor deposition synthesis, opening of carbon nanotubes, unrolling of carbon nanoscrolls, and the like. In some embodiments, the graphene is functionalized graphene. Functionalized graphene is distinguished from pristine graphene by the presence of functional groups on the surface or edge of the graphene that contain elements other than carbon and hydrogen. In some embodiments, the graphene is graphene oxide. Graphene oxide refers to graphene that has various oxygen-containing functionalities that are not present in pristine graphene. Examples of such oxygen-containing functionalities include epoxides, carbonyl, carboxyl, and hydroxyl functional groups. Graphene oxide is sometimes considered to be a type of functionalized graphene.

In some embodiments, the graphene is reduced graphene oxide. Reduced graphene oxide (rGO) refers to graphene oxide that has been chemically reduced. It is distinct from graphene oxide in it contains substantially fewer oxygen-containing functionalities compared to graphene oxide, and it is distinct from pristine graphene by the presence of oxygen-containing functionalities and structural defects in the carbon network. Reduced graphene oxide is sometimes considered to be a type of functionalized graphene. In preferred embodiments, the carbon nanomaterial is reduced graphene oxide. The reduced graphene oxide may exist as nanosheets, particles having a spherical shape, or may be shaped like blocks, flakes, ribbons, discs, granules, platelets, angular chunks, rectangular prisms, or some other shape as described above, agglomerates as described above, or any other shape known to one of ordinary skill in the art.

In some embodiments, the carbon nanoparticles are activated carbon. Activated carbon refers to a form of porous carbon having a semi-crystalline, semi-graphitic structure and a large surface area. Activated carbon may be in the form of particles or particulate aggregates having micropores and/or mesopores. Activated carbon typically has a surface area of approximately 500 to 5000 m²/g. The activated carbon particles may have a spherical shape, or may be shaped like sheets, blocks, flakes, ribbons, discs, granules, platelets, angular chunks, rectangular prisms, or some other shape. In some embodiments, the activated carbon particles may be substantially spherical, meaning that the distance from the activated carbon particle centroid (center of mass) to anywhere on the activated carbon particle outer surface varies by less than 30%, preferably by less than 20%, more preferably by less than 10% of the average distance.

In some embodiments, the carbon nanoparticles are carbon black. Carbon black refers to having a semi-crystalline, semi-graphitic structure and a large surface area. Carbon black may be distinguished from activated carbon by a comparatively lower surface area, typically 15 to 500 m²/g for carbon black. Additionally, carbon black may lack the requisite micropores and mesopores of activated carbon. The carbon black particles may have a spherical shape, or may be shaped like sheets, blocks, flakes, ribbons, discs, granules, platelets, angular chunks, rectangular prisms, or some other shape.

In some embodiments, the particles of a carbon nanomaterial are a single type of particle as described above. In this context, “a single type of particle” may refer to particles of a single carbon nanomaterial, particles which have substantially the same shape, particles which have substantially the same size, or any combination of these. In some embodiments, mixtures of types of particles are used.

In some embodiments, the carbon-containing porous scaffold exists as particles that are not separate from the metal-organic framework particles. That is, the carbon-containing porous scaffold may be embedded in, present on the surface of, or otherwise associated with the metal-organic framework particles, or vice-versa.

In some embodiments, the nanoparticles are at least one selected from cobalt-nickel alloy nanoparticles and copper oxide nanoparticles. In general, the nanoparticles can have any suitable shape as described above. In some embodiments, the carbonized product includes CoNi nanoparticles, and the carbonized product further includes β-Co nanoparticles. The cobalt-nickel alloy nanoparticles have a mean size of 1 to 50 nanometers (nm), such as 1 nm, 2 nm, 3 nm, 4 nm, 5 nm, 7.5 nm, 10 nm, 12.5 nm, 15 nm, 17.5 nm, 20 nm, 22.5 nm, 25 nm, 27.5 nm, 30 nm, 32.5 nm, 35 nm, 37.5 nm, 40 nm, 42.5 nm, 45 nm, 47.5 nm, or 50 nm.

In some embodiments, the carbonized product includes copper oxide nanoparticles. The copper oxide nanoparticles include CuO and Cu₂O by PXRD. The copper oxide nanoparticles have a mean size of 1 to 50 nm, such as 1 nm, 2 nm, 3 nm, 4 nm, 5 nm, 7.5 nm, 10 nm, 12.5 nm, 15 nm, 17.5 nm, 20 nm, 22.5 nm, 25 nm, 27.5 nm, 30 nm, 32.5 nm, 35 nm, 37.5 nm, 40 nm, 42.5 nm, 45 nm, 47.5 nm, or 50 nm.

The catalytic electrode can be used to electrochemically form oxygen. Electrochemically forming oxygen refers to generating oxygen gas (O₂) through an electrochemical reaction, typically via water electrolysis. In this process, an electric current is passed through water, causing the oxidation of water molecules at the anode, which releases oxygen gas.

In some embodiments, a potential of 0.01 to 1.5 V is applied to the catalytic electrode in an aqueous electrolyte solution. For example, the potential can be 0.01 V, 0.05 V, 0.1 V, 0.15 V, 0.20 V, 0.25 V, 0.30 V, 0.35 V, 0.40 V, 0.45 V, 0.50 V, 0.55 V, 0.60 V, 0.65 V, 0.70 V, 0.75 V, 0.80 V, 0.85 V, 0.90 V, 0.95 V, 1.00 V, 1.05 V, 1.10 V, 1.15 V, 1.20 V, 1.25 V, 1.30 V, 1.35 V, 1.40 V, 1.45 V, or 1.50 V. The potential may be applied relative to a counter electrode immersed in the aqueous electrolyte solution. In general, the counter electrode can be any suitable type of electrode. Examples of electrodes which may be used as the counter electrode include, but are not limited to, platinum, gold, graphite, carbon, nickel, copper, titanium, aluminum, stainless steel, iridium, tungsten, rhodium, palladium, iridium oxide, ruthenium oxide, conductive polymer, carbon nanotubes, carbon black, conductive glass, ITO (indium tin oxide), FTO (fluorine-doped tin oxide), glassy carbon, doped silicon, lead, bismuth, cobalt, zinc, copper oxide, iron, tin, zirconium, molybdenum, manganese, tungsten carbide, graphite oxide, copper sulfate, nickel oxide, carbon fiber, titanium oxide, and diamond-like carbon. In some embodiments, the counter electrode is silver/silver chloride.

In some embodiments, the aqueous electrolyte solution includes a hydroxide base. In some embodiments, the aqueous electrolyte may include, but is not limited to, sodium hydroxide, potassium hydroxide, calcium hydroxide, magnesium hydroxide, ammonium hydroxide, lithium hydroxide, barium hydroxide, sodium carbonate, potassium carbonate, sodium bicarbonate, potassium bicarbonate, ammonium carbonate, sodium phosphate, potassium phosphate, sodium borate, sodium acetate, potassium acetate, sodium formate, potassium formate, sodium silicate, sodium thiosulfate, potassium dichromate, sodium cyanide, potassium cyanide, sodium permanganate, potassium permanganate, sodium nitrite, potassium nitrite, copper(II) sulfate, zinc sulfate, and iron(III) chloride. In a preferred embodiment, the base is KOH. In some embodiments, the concentration of the hydroxide base in the aqueous electrolyte solution is 0.1 to 5 M, such as 0.1 M, 0.25 M, 0.50 M, 0.75 M, 1.0 M, 1.25 M, 1.5 M, 1.75 M, 2.0 M, 2.25 M, 2.5 M, 2.75 M, 3.0 M, 3.25 M, 3.5 M, 3.75 M, 4.0 M, 4.25 M, 4.5 M, 4.75 M, or 5.0 M.

In some embodiments, when the carbonized product includes CoNi nanoparticles, the method has a potential required to generate a current density of 50 milliamperes per square centimeter (mAcm⁻²) (η50) of 300 to 400 millivolts (mV), preferably 320 to 360 mV, preferably 350 mV relative to the reversible hydrogen electrode. In some embodiments, when the carbonized product includes CoNi nanoparticles, the method has a Tafel slope of 60 to 90 mV/dec, preferably 75 to 85 mV/dec, preferably 78 mV/dec.

In some embodiments, when the carbonized product includes copper oxide nanoparticles including CuO and Cu₂O, the method has a potential required to generate a current density of 50 mAcm⁻² (η50) of 420 to 560 mV, such as 430, 480, 490, or 530 mV relative to the reversible hydrogen electrode. In some embodiments, when the carbonized product includes copper oxide nanoparticles including CuO and Cu₂O, the method has a Tafel slope of 140 to 175 mV/dec, preferably 142 to 150 mV/dec, preferably 144 mV/dec.

### EXAMPLES

The following examples demonstrate a method of producing the electrocatalyst and for producing hydrogen gas by a hydrogen evolution reaction (HER) using electrocatalyst. The examples are provided solely for illustration and are not to be construed as limitations of the present disclosure, as many variations thereof are possible without departing from the spirit and scope of the present disclosure.

### Example 1: Materials

The materials and chemicals used in the present disclosure are described hereinafter, with corresponding purity percentage, trimesic acid (TPA, C₆H₃(CO₂H)₃, 98%), nickel nitrate hexahydrate (Ni(NO₃)₂·6H₂O, 99.99%), cobalt nitrate hexahydrate (Co(NO₃)₂·6H₂O, 99.99%), methanol (CH₃OH, 99.9%), N, N-dimethylformamide (DMF, 99.8%, H₂O), acetic acid (CH₃COOH, 99.0%), dichloromethane (CH₂Cl₂, 99.8% extra-dry grade). Further, zinc nitrate hexahydrate (Zn(NO₃)₂·6H₂O), 2-methylimidazole (H—MeIM), copper nitrate trihydrate (Cu(NO₃)₂·3H₂O), and cobalt nitrate hexahydrate (Co(NO₃)₂·6H₂O) were used as reagents. Nickel foam with a thickness of about 1.6 mm and a porosity percentage of about 95% was acquired from Good-fellow Cambridge. The Milli-Q water was used to prepare the electrolyte solution.

### Example 2: Synthesis of CoNi-Btc, Metal-Organic Framework (MOF)

To synthesize CoNiBTC, 0.5 millimole (mmol) of Ni(NO₃)₂·6H₂O, 0.5 mmol of Co(NO₃)₂·6H₂O, and 1.0 mmol of trimesic acid were dissolved in about 20 mL of dimethylformamide (DMF) and an ultrasonic vibration was used for 15 minutes to facilitate the dissolution of salt. Further, 5 mL of acetic acid (CH₃COOH) was added to the aforementioned solution. The solution was transferred to a 40 mL steel autoclave at a temperature of about 448 Kelvin (K) for 72 hours. The resulting precipitate was cooled to room temperature, and a microcrystalline powder was collected and washed with 10 mL DMF per rinse, thrice, for 3 days, followed by washing with 10 mL dichloromethane (CH₂Cl₂) per rinse, thrice, for subsequent 3 days.

### Example 3: Synthesis of Zeolitic Imidazolate Framework (ZIF-8)

ZIF-8 catalyst was synthesized by mixing 0.210 grams (g) of zinc nitrate tetrahydrate (Zn(N₃)₂·4H₂O), equivalent to 8.03×10⁻⁴ moles, with 0.060 g of 2-methylimidazole (H—MeIM), equivalent to 7.31×10⁻⁴ moles, in a 20 milliliter (mL) vial containing 18 mL of DMF. Further, the vial was sealed and heated in an oven at a temperature rate of 5° C. per minute until a temperature of 140° C. was reached. The temperature was maintained at 140° C. for the next 24 h. The oven was cooled to room temperature, and the vial was opened. Further, the mother liquor was removed, and the vial was filled with 20 mL of chloroform. Furthermore, colorless polyhedral crystals formed in the upper layer were collected, rinsed three times with 10 mL of DMF per rinse, and air-dried for 10 minutes.

### Example 4: Synthesis of HKUST-1

HKUST-1 MOF was prepared by dissolving 4.2 g of cupric nitrate trihydrate (Cu(NO₃)₂·3H₂O) in 33 mL of distilled water. Further, 2.10 g of benzene-1,3,5-tricarboxylic acid was dissolved in 67 mL of a solvent mixture including DMF and ethanol in a volume ratio of about 1:1. Further, the two solutions were combined and thoroughly stirred, followed by the addition of acetic acid as a modulator. Furthermore, the resulting solution was transferred to a Teflon-lined stainless-steel autoclave and heated in an oven at 120° C. for 12 h. Moreover, after completion of the heating process, the autoclave was allowed to cool naturally to room temperature, and the resulting products were collected by filtration and washed with DMF and methanol. The resulting products were dried at room temperature.

### Example 5: Characterization of the MOFs.

The crystallographic information of the alloy samples was evaluated and acquired using X-ray diffraction (XRD), Rigaku MiniFlex, utilizing the Cu Kα radiation (λ=1.5418 Å). Further, the morphology of the resulting thin films was characterized using a scanning electron microscope (SEM), JEOL JSM-6610LV, Japan. In addition, laser annealing was performed using a Universal laser system, Model 2.30 DT, at a power of about 30 watts (W).

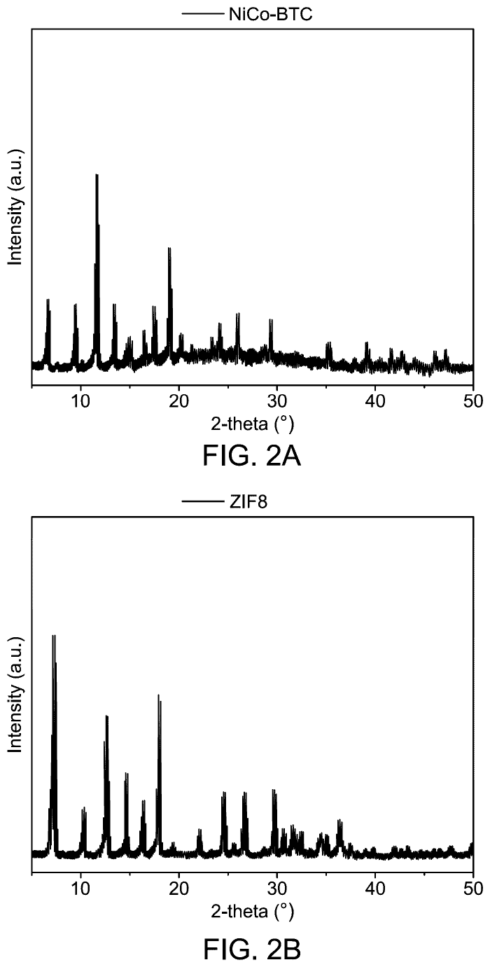

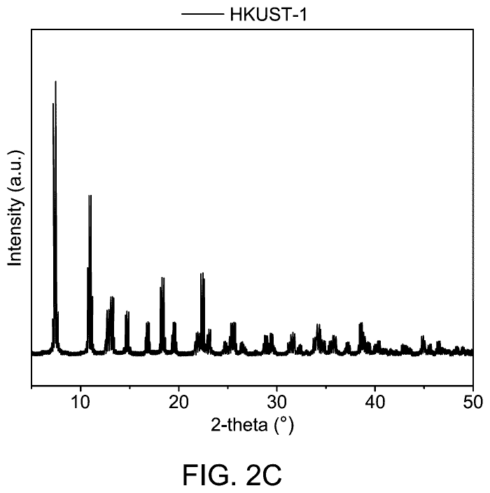

The XRD patterns of NiCo BTC and HKUST-1 exhibited distinct peaks, confirming the successful synthesis of these MOFs, as shown in FIGS. 2A-2C. The observed peaks correspond to the characteristic crystalline planes associated with specific framework topologies. Similarly, the ZIF-8 was examined using XRD, which revealed sharp peaks at specific angles, indicative of a highly crystalline sodalite-type structure, as shown in FIG. 2B. The similarity of the observed diffraction patterns with standard reference data verifies the formation of the desired porous structures. Furthermore, the peak positions and intensities provide information about the purity and phase of the synthesized MOFs, enabling a thorough characterization of the materials.

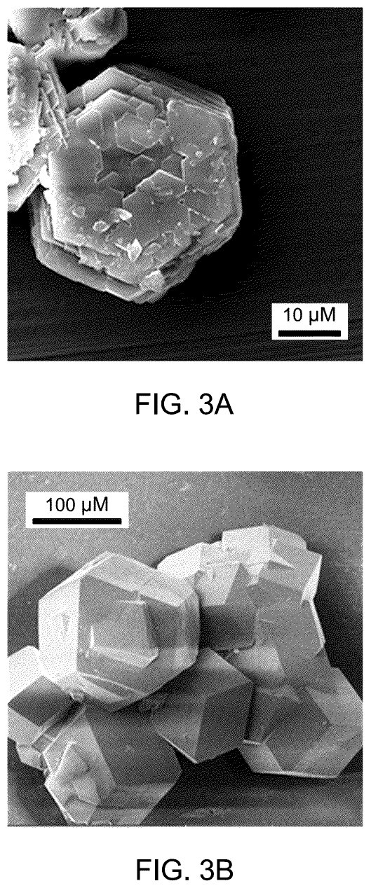

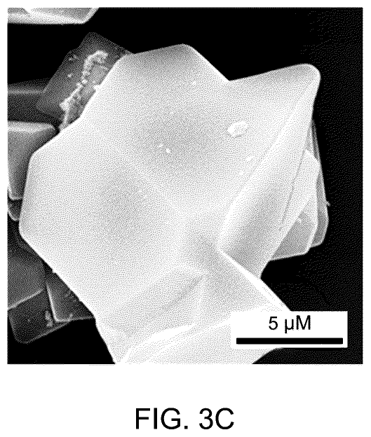

Referring to FIGS. 3A-3C, field emission scanning electron microscopy (FESEM) images of NiCo BTC, ZIF-8, and HKUST-1 are illustrated. As can be seen from FIG. 3A, the prepared NiCo BTC MOF catalyst exhibited cubic crystals aggregated into clusters at the micro-scale. The ZIF-8 catalyst framework showed a distinctive dodecahedral crystal morphology with well-defined edges, indicative of high crystallinity, as shown in FIG. 3B. Furthermore, the HKUST-1 MOF exhibited facets characterized by octahedral crystals, as shown in FIG. 3C.

### Example 6: Characterization of the Laser-Annealed MOFs.

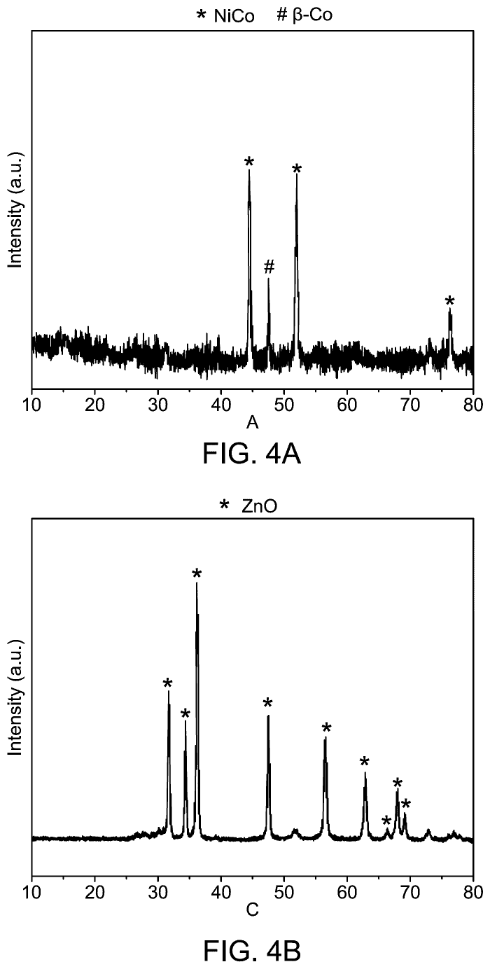

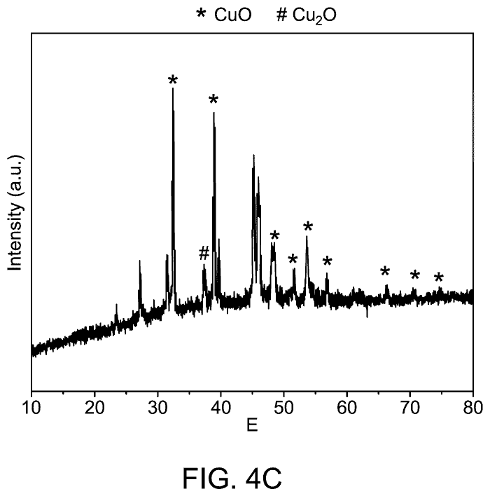

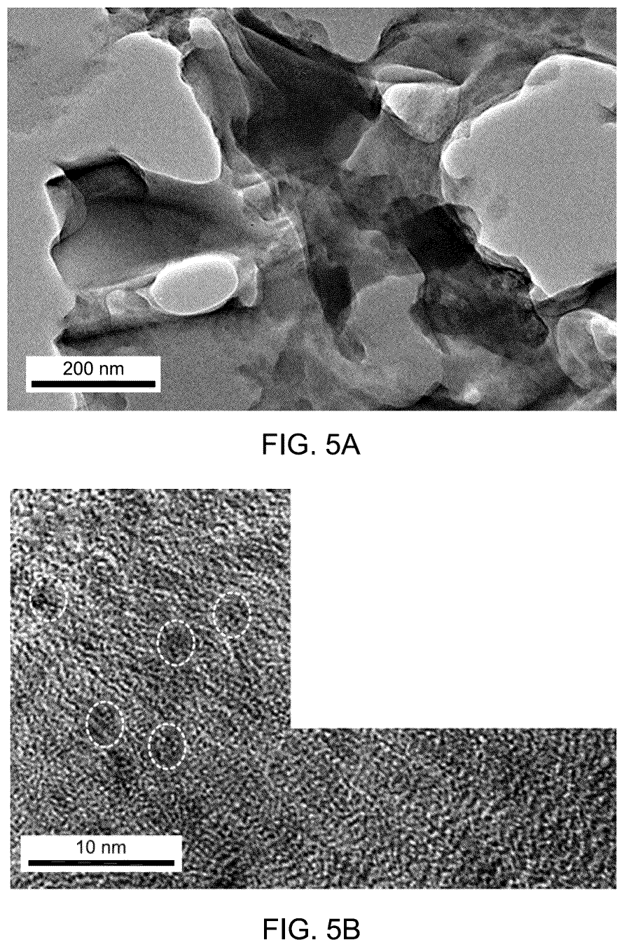

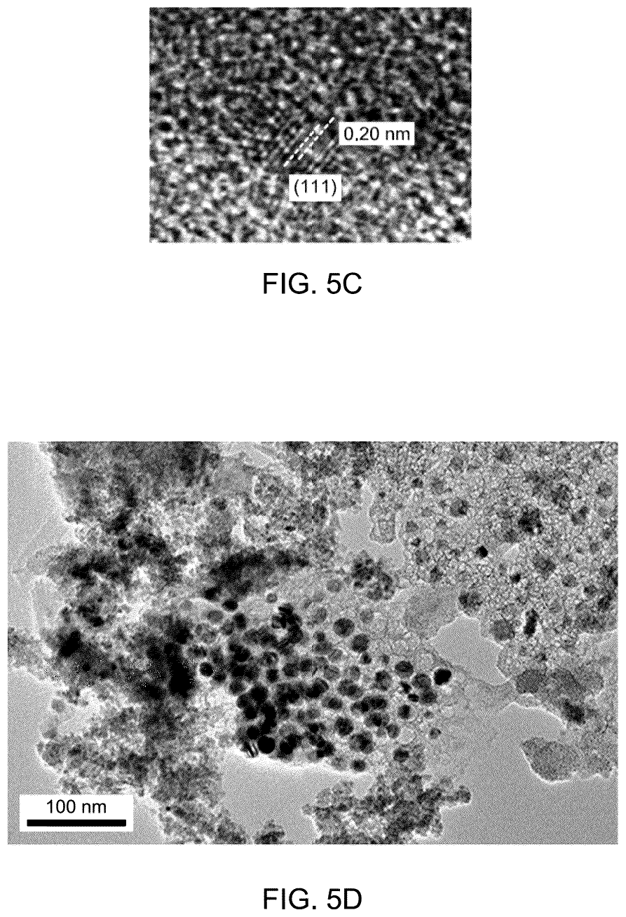

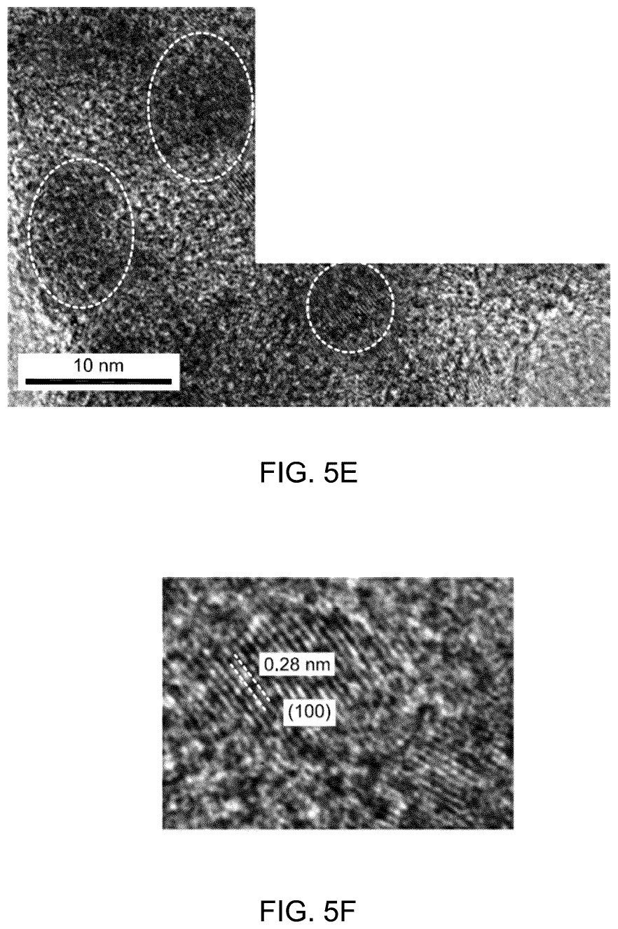

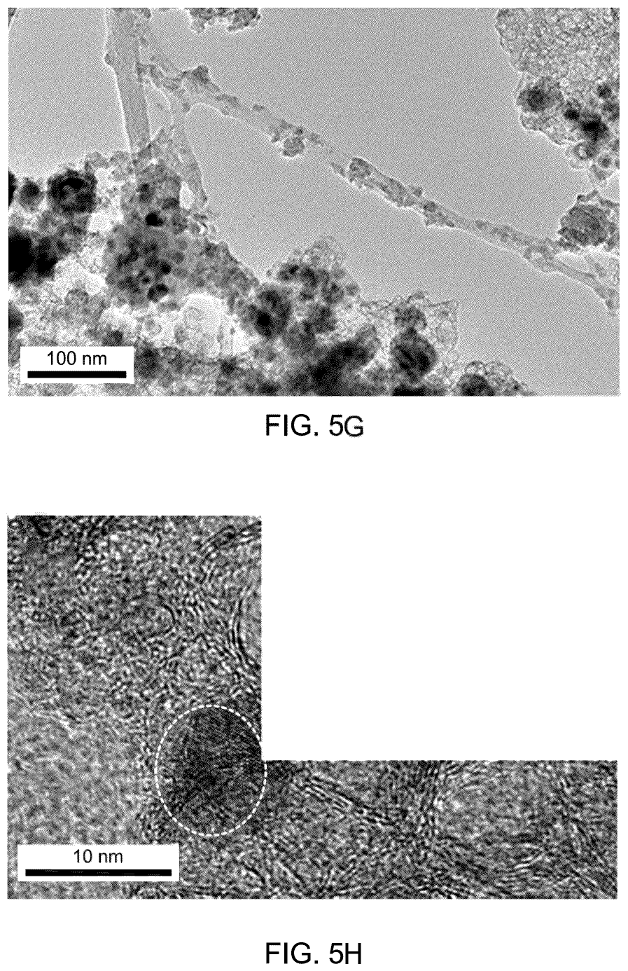

The laser-annealed MOFs deposited on nickel foam were subjected to ultrasonication in ethanol to detach the MOF powder from the nickel foam substrate. Following detachment, the powder was carefully collected and dried under a vacuum at a temperature of about 60° C. Post drying phase, the laser-annealed MOFs were subjected to XRD to elucidate the crystalline structure of the laser-annealed MOFs, providing insights into the phase purity and crystallite size. Further, the TEM and HRTEM analyses were conducted to visualize the morphology and nanostructure of the laser-annealed MOFs. The findings from comprehensive examinations are systematically illustrated, as shown in FIGS. 4A-4C and FIGS. 5A-5F.

Further, the XRD analysis provides insights into the structural transformation induced by laser annealing of the MOFs, as shown in FIGS. 4A-4C. The laser-annealing of NiCo BTC MOF exhibited characteristic diffraction peaks corresponding to the formation of a NiCo alloy phase, as shown in FIG. 4A. The peaks indicate the presence of the desired NiCo alloy structure. Additionally, the presence of a peak attributed to the β-Cobalt (β-Co) phase indicates the partial transformation of the initial MOF structure into the crystalline phase during the laser annealing process. Further, the XRD pattern of the laser-annealed ZIF-8 reveals a complete transformation into the zinc oxide (ZnO) crystal structure, as shown in FIG. 4B. All the observed diffraction peaks may be indexed to the standard reference data for ZnO, indicating the successful conversion of the MOF precursor into the metal oxide phase. The absence of residual peaks associated with the initial ZIF-8 structure indicates a comprehensive structural transformation. Furthermore, the XRD analysis of the laser-annealed HKUST-1 MOF, as depicted in FIG. 4C, illustrates the formation of CuO as the primary phase, evidenced by the peaks shown. However, a phase corresponding to Cu₂O was observed for samples, indicating the coexistence of the two copper oxide phases within the annealed sample. The appearance of the diffraction peaks indicates the decomposition of the HKUST-1 MOF and the subsequent formation of the respective copper oxide phases under the influence of laser annealing.

As can be seen from FIGS. 5A-5F, the TEM and HRTEM analysis shows the structural transformations and nanostructures formed upon laser annealing of the MOFs. The TEM image, as shown in FIG. 5A, depicts a nanocrystalline morphology, indicating the formation of nanocrystalline domains within the material in the case of the laser-annealed NiCo BTC MOF. The HRTEM image, as shown in FIG. 5B, further indicates the formation of NiCo nanoalloys, as evidenced by the circular regions marked in the FIG. 5B. The HRTEM image displayed in FIG. 5C shows distinct lattice fringes with an interplanar spacing of 0.20 nm, corresponding to the (111) plane of the NiCo alloy phase. The observation confirms the successful conversion of the initial MOF structure into the desired NiCo nanoalloy upon laser annealing. For the laser-annealed ZIF-8 sample, FIG. 5D depicts a spherical morphology of ZnO nanoparticles embedded within a carbon network. The distinctive nanostructure is formed by the decomposition of the ZIF-8 MOF and the successive formation of ZnO nanoparticles within the carbon matrix. Further, FIG. 5E indicates the presence of ZnO, with FIG. 5F displaying lattice fringes with an interplanar spacing of 0.28 nm, corresponding to the (100) plane of the ZnO crystal structure. In the case of the laser-annealed HKUST-1 MOF, the TEM image is shown in FIG. 5G depicts particle morphology within a carbon skeleton. The morphology indicates the formation of nanoparticles or crystallites within the carbon matrix, resulting from the decomposition of the initial MOF structure during laser annealing. The HRTEM image, as shown in FIGS. 5H and 5I, show lattice fringes with an interplanar spacing of 0.22 nm, corresponding to the (110) plane of a crystalline phase, related to the expected copper oxide phases formed during the annealing process.

### Example 7: Preparation of Thermal Annealed Electrodes-Conventional Method

The MOF was thermally annealed in a nitrogen-filled tubular furnace with a nitrogen flow rate of 25 milliliters per minute (mL/min). In particular, 50 mg of MOF was placed in an alumina boat and inserted into the furnace. The temperature was increased by 5° C. /min until it reached 550° C. and maintained for 2 h. Further, the furnace was allowed to cool down at room temperature, and the annealed powder was collected.

In accordance with the present disclosure, the electrodes were fabricated using the drop-casting method. The ink was prepared by mixing 10 mg of the annealed powder with a ratio of about 80:20 for an isopropanol-water solution. The obtained mixture was then treated with 10 microliters ( μL) of 5% Nafion solution and sonicated for 30 minutes. The ink was further drop cast onto a nickel foam substrate with an area of 1 cm² and a mass loading of 1 mg/cm². The resultant electrode was air-dried before use.

### Example 8: Preparation of Laser-Annealed Electrodes

In accordance with the present disclosure, the nickel foam (NF) pieces (1×2) cm in size, were cleaned in an ultrasonic bath for 10 min prior to the deposition of thin film. The cleaning process involved diluted hydrochloric acid (HCl), acetone (CH₃COCH₃), and ethanol. Further, the NF was rinsed with deionized (DI) water and dried with high-purity nitrogen (N₂) gas. The MOF was deposited on both sides of an NF substrate by drop-casting a suspension of 60 mg of CoNi BTC MOF in ethanol, which was previously ultrasonicated for 30 minutes. The mass loading of the MOF was 10 mg/cm⁻². The CoNiBTC/NF was then subjected to laser annealing using a CO₂ laser machine with a wavelength of 10.6 μm, a maximum power of 30 W and a speed of 1780 millimeters per second (mm s⁻¹), under ambient conditions. The power of the laser beam was adjusted while keeping the speed constant at around 100 mm s⁻¹ to transform the CoNiBTC/NF into a carbonized structure on NF, denoted as LA-CoNiBTC/NF. The LA-CoNiBTC/NF film was further cleaned by ultrasonication in ethanol to remove any residual untreated or carbonized particles and dried in a vacuum oven.

### Example 9: Evaluation of HER and OER Performance-Electrochemical Measurements

Further, the electrocatalytic water oxidation was evaluated via a computer-controlled Autolab potentiostat workstation using the Nova 2.1.6 interface. A three-electrode cell system consisting of Ag/AgCl, platinum (Pt) rod, and CoNi or FeCoNi film electrodes deposited on nickel foam and immersed in 1.0 M potassium hydroxide (KOH) electrolyte were used as the reference, counter, and working electrodes, respectively. Cyclic voltammetry (CV) analysis was conducted in the potential range of 0 V to 1 V vs. Ag/AgCl in order to activate the surface of the catalyst for water oxidation. The linear sweep voltammetry (LSV) test was conducted at a scan rate of 5 mVs⁻¹ and the data obtained were reported after iR corrections. In addition, electrochemical impedance spectroscopy (EIS) was conducted at a potential of 1.50 V in the frequency range from 0.01 Hz to 100 kHz. The chronopotentiometry (CP) method was used to evaluate the catalytic durability of the prepared samples at the current densities of 50 mA cm⁻² and 100 mA cm⁻². All measured potentials were converted to the reversible hydrogen electrode (RHE).

### Example 10: HER and OER Performance Results

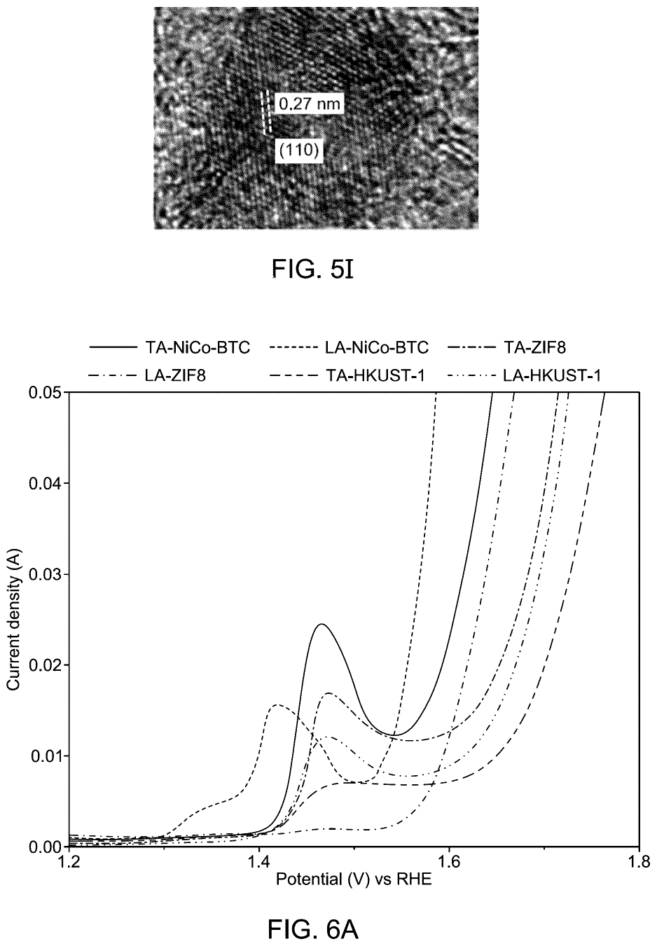

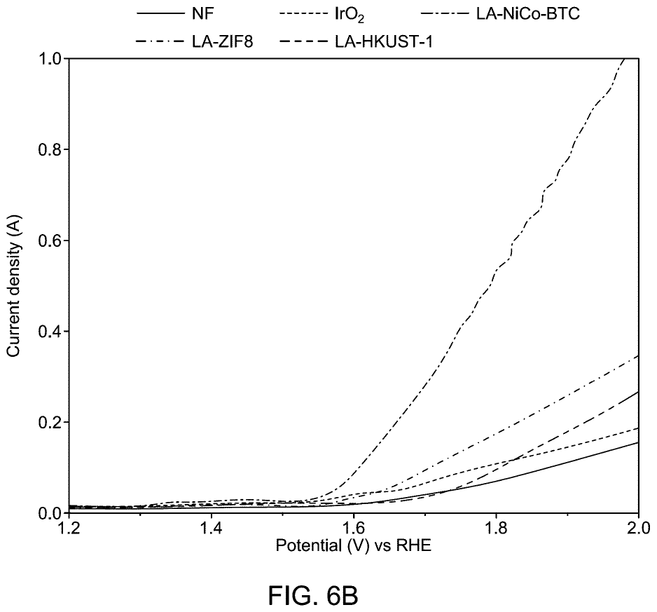

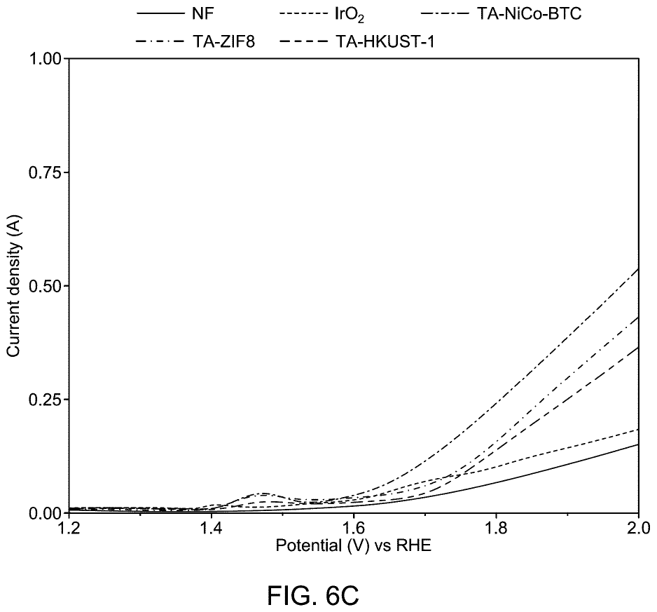

The OER performance of MOF-derived electrodes was assessed using LSV with a scan rate of 5 mVs⁻¹. Further, the LSV curves of the laser-annealed MOFs, as well as those of the NF and IrO2 reference catalyst, are shown in FIG. 6B. Further, the LSV curves of the thermally annealed MOFs in comparison with the NF and the IrO₂ catalyst are shown in FIG. 6C. The combined LSV characteristics are presented in FIG. 6A. As can be understood from FIGS. 6A-6C, the laser-annealed MOF exhibits superior catalytic activity, as indicated by the lower overpotential values and higher current density of the samples. According to the current density, the order of performance for the laser-annealed and thermally annealed MOF-derived electrodes was observed as follows: NiCo BTC>ZIF-8>Ni-HKUST>IrO₂>NF. However, when observed with respect to overpotential, the order is as follows: NiCo BTC>IrO₂>ZIF-8>Ni-HKUST>NF.

In general, a common way to evaluate the electrocatalytic activity of various materials is to use the current density of 10 mA cm⁻² as a reference point since the current density reflects the overpotential needed to drive the electrochemical reactions. The overpotential is the key difference between the actual and the theoretical potential of the electrocatalytic process, and the overpotential is influenced by the intrinsic properties of the catalyst, such as the surface area, the activity, and the stability. In some examples, the Ni oxidation peak for the annealed MOFs exhibited a current density above 10 mA. Hence, the electrodes were evaluated at 50 mA current density in terms of overpotential.

The overpotential observations for laser-annealed and thermally annealed MOFs were noted. It may be concluded that each laser annealed MOF had a lower overpotential than the corresponding thermal annealed MOF when reaching a current density of 50 mA cm⁻². The laser annealed NiCo BTC had the lowest overpotential of 350 mV to achieve a current density of 50 mA cm⁻². In comparison, the thermally annealed NiCo BTC required an overpotential of 410 mV for the same current density of 50 mA cm⁻². Further, the overpotential required for the laser-annealed ZIF-8 and Ni-HKUST were 430 mV and 490 mV, respectively, while the thermal annealed MOFs required 480 mV and 530 mV, respectively.

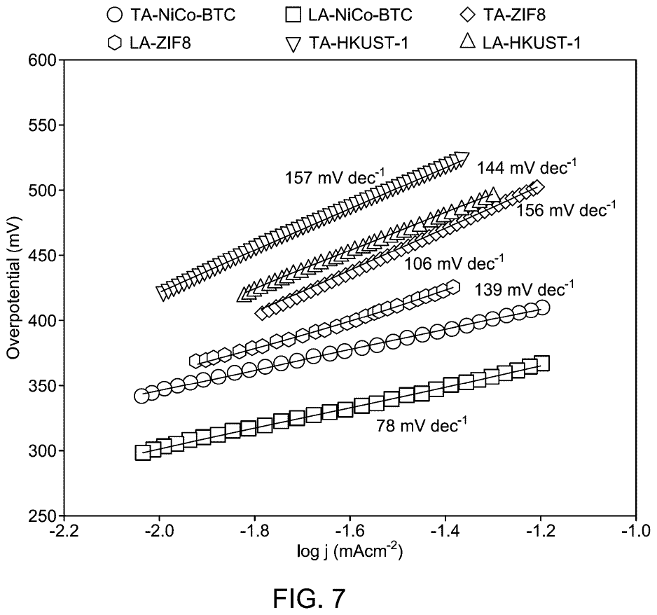

To further examine the kinetics of the electrocatalytic reaction, the Tafel plots are shown in FIG. 7. The plot shows that the thermally annealed MOFs exhibit lower Tafel values compared to the laser-annealed MOFs in each case. Among the laser-annealed MOFs, NiCo BTC exhibited the lowest Tafel slope of 78 mV dec⁻¹, followed by ZIF8 with a Tafel slope of 105 mV dec⁻¹ and Ni-HKUST with 144 mV dec⁻¹. The results indicate that the NiCo BTC electrode demonstrated the highest electrocatalytic activity and the fastest kinetics compared to the other electrodes. The laser annealing process changed the morphology and composition of the MOFs, increasing MOFs conductivity and enhancing the charge transfer kinetics of MOFs. The laser annealing process resulted in a better catalytic performance of the laser-annealed electrodes for the oxygen evolution reaction (OER). In addition, high conductivity is vital for electroactive catalysts, as it facilitates efficient charge transport, minimizes potential drop, and enhances overall catalytic performance.

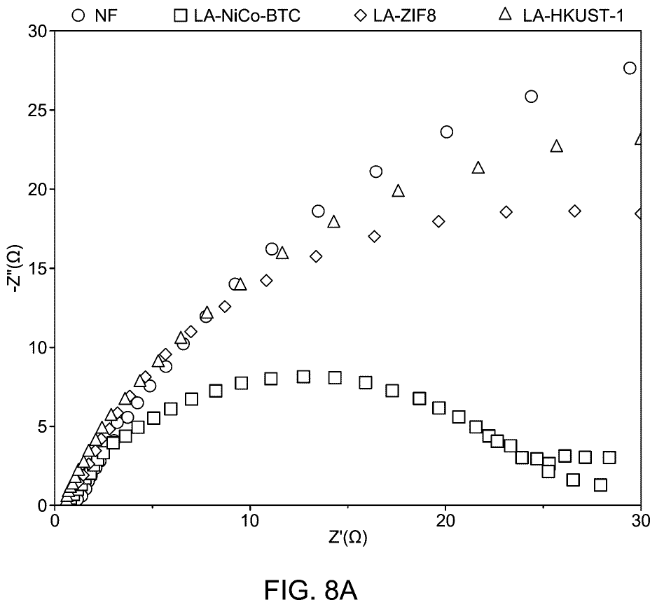

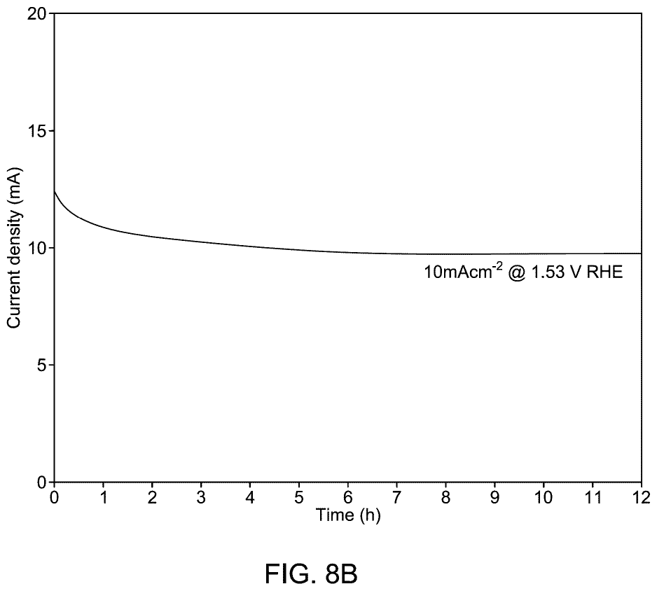

Furthermore, electrochemical impedance spectroscopy (EIS) measurements were conducted at a constant overpotential of 1.5 V vs RHE. The electrochemical kinetics of the developed laser-annealed electrodes and Nyquist plots are shown in FIGS. 8A-8B.

In general, a parameter for enhancing the electrochemical performance of catalysts is to reduce the charge transfer resistance (R_{ct}), which measures the ease of electron transfer across the interfaces between the electrode, the electrolyte, and the catalyst. Lower R_{ct} may translate to faster electron transfer and higher electrochemical activity. The charge transfer resistance values (R_{ct}) from the equivalent series indicated that the NiCo MOF has lower resistance than laser-annealed ZIF-8 and laser-annealed HKUST-1 electrodes. The observations indicate that the NiCo electrode has a high efficiency of electron transfer and a large number of active sites. The enhanced electron transport rate may be ascribed to the laser annealing process. The laser-annealed MOFs may have resulted in better structure and morphology and improved interface activity. The laser-annealed NiCo BTC electrode was tested for long-term stability in 1 M KOH at 1.53 V vs. RHE as a potential oxygen evolution reaction (OER) catalyst. The electrode was stable for 12 hours, with no significant degradation in the current density or overpotential. The results demonstrate that the laser-annealed NiCo BTC electrode may be desirable for OER applications in alkaline media.

Numerous modifications and variations of the present disclosure are possible in light of the above teachings. It is, therefore, to be understood that within the scope of the appended claims, the invention may be practiced otherwise than as specifically described herein.

1. A method of forming a catalytic electrode, the method comprising
depositing particles of a metal-organic framework onto a conductive substrate to form a coated substrate; and
exposing the coated substrate to a laser having a wavelength of 5 to 10 μm and a power of 25 to 35 W to form a carbonized product; wherein
the metal-organic framework is at least one selected from the group consisting of a copper-containing metal-organic framework and a cobalt/nickel-containing metal-organic framework; and
the carbonized product comprises
a carbon-containing porous scaffold, and
nanoparticles which are at least one selected from the group consisting of cobalt-nickel alloy nanoparticles and copper oxide nanoparticles disposed on the carbon-containing porous scaffold.

2. The method of claim 1, wherein
the copper-containing metal-organic framework is HKUST-1 and the carbonized product comprises CuO crystallites having an average diameter of from 5 to 15 nm.

3. The method of claim 1, wherein the cobalt/nickel-containing metal-organic framework
comprises cobalt, nickel, and a benzenetricarboxylic acid or salt thereof, and
has an atomic ratio of cobalt to nickel of 0.5:1 to 2:1.

4. The method of claim 3, wherein
the benzenetricarboxylic acid or salt thereof is 1,3,5-benzenetricarboxylic acid or salt thereof.

5. The method of claim 1, wherein
the cobalt-nickel alloy nanoparticles are CoNi nanoparticles, and
the carbonized product further comprises β-Co nanoparticles.

6. The method of claim 1, wherein
the cobalt-nickel alloy nanoparticles have a mean size of 1 to 50 nm.

7. The method of claim 1, wherein
the copper oxide nanoparticles comprise CuO and Cu₂O by PXRD.

8. The method of claim 1, wherein
the copper oxide nanoparticles have a mean size of 1 to 50 nm.

9. The method of claim 1, wherein
the conductive substrate is nickel foam.

10. The method of claim 1, wherein
the metal-organic framework is present on the conductive substrate at a surface density of to 25 mg/cm².

11. The method of claim 1, wherein
the laser is a CO₂ laser having a wavelength of 10.6 μm.

12. The method of claim 1, wherein
the laser is passed across a surface of the coated substrate at a rate of 50 to 500 mm/s.

13. The method of claim 1, wherein
the exposing is performed in ambient atmosphere.

14. The method of claim 1, wherein
the metal-organic framework is substantially free of zinc.

15. The method of claim 2, wherein the depositing is performed by
mixing copper nitrate and 1,3,5-benzenetricarboxylic acid in a solvent comprising ethanol and dimethylformamide to form a reaction mixture;
hydrothermally treating the reaction mixture at 100° C. to 150° C. for 6 to 24 hours to form the particles of the metal-organic framework; and
ultrasonically treating a deposition mixture comprising the conductive substrate, the particles of the metal-organic framework, and ethanol to form the coated substrate.

16. The method of claim 3, wherein the depositing is performed by
mixing nickel nitrate, copper nitrate, and 1,3,5-benzenetricarboxylic acid in a solvent comprising dimethylformamide and acetic acid to form a reaction mixture;
hydrothermally treating the reaction mixture at 150° C. to 200° C. for 24 to 120 hours to form the particles of the metal-organic framework; and
ultrasonically treating a deposition mixture comprising the conductive substrate, the particles of the metal-organic framework, and ethanol to form the coated substrate.

17. A method of electrochemically forming oxygen, the method comprising
forming a catalytic electrode by the method of claim 1; and
applying a potential of 0.01 to 1.5 V to the catalytic electrode in an aqueous electrolyte solution comprising a hydroxide base.

18. The method of claim 17, wherein
the aqueous electrolyte solution comprising a hydroxide base is 1.0 M KOH.

19. The method of claim 17, wherein
the carbonized product comprises CoNi nanoparticles; and
the method has
a potential required to generate a current density of 50 mAcm⁻² (η50) of 300 to 400 mV relative to the reversible hydrogen electrode, and
a Tafel slope of 60 to 90 mV/dec.

20. The method of claim 17, wherein
the carbonized product comprises copper oxide nanoparticles including CuO and Cu₂O; and
the method has
a potential required to generate a current density of 50 mAcm⁻² (η50) of 420 to 560 mV relative to the reversible hydrogen electrode, and
a Tafel slope of 140 to 175 mV/dec.
